(19) United States
(12) Patent Application Publication
(10) Pub. No.: US 2009/0324980 A1
(43) Pub. Date: Dec. 31, 2009

(54) Process for Producing Coated Paper and Coated Paper

(75) Inventor: Tadahiro Matsushima, Shikokuchuo-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Daio Paper Corporation, Shikokuchuo-shi, Ehime (JP)

(21) Appl. No.: 11/922,533

(22) PCT Filed: Jun. 15, 2006
(86) PCT No.: PCT/JP2006/312058

§ 371 Date: Feb. 23, 2009

(30) Foreign Application Priority Data
Jun. 20, 2005 (JP) 2005-179111
Nov. 17, 2005 (JP) 2005-332733

(51) Int. Cl. B32B 29/00; B05D 1/28

(52) U.S. Cl. 428/537.5; 427/211

(57) ABSTRACT

A process for forming coating layers on a surface of a base paper, using coating apparatuses differing in coating method in which at least two coating layers are formed on the surface layer of the base paper, and in particular, the base paper is coated by a combination of coating by a roll coater and coating by a blade coater.

### TECHNICAL FIELD

The present invention relates to a process and apparatus for producing a coated paper.

In particular, the present invention involves using, as means for forming coating layers on a surface of a base paper, coating apparatuses differing in coating method, for example, coating apparatuses including a combination of a-roll coater and a blade coater that form at least two coating layers on a surface layer of the base paper. The present invention suitably relates to a process for producing a coated paper that can efficiently carry out production with high quality at a speed of 1300 m/min or more, particularly at a high speed of 1550 m/min or more integratedly from paper to finally finished products by means of on-machine technology, and coated paper.

### BACKGROUND ART

In response to recent promotion of visualization and changes to multimedia, needs have been rapidly increased to highly qualify such as to visualize and colorize even printed matters having been widely used as media such as publications, advertisements, and posters. With changes in such user demands, an increase in the replacement of a conventional uncoated printing paper by a coated paper for printing rapidly leads to increasing demand for the coated paper for printing.

In addition, printing steps more and more severely request the qualities of handling properties of printing paper and traveling stability on a printer, which are involved in improvement in workability and efficiency.

Of the quality requests, paper manufacturing industries have implemented involvements with wider and more highly speedy paper machines in order to save energy and reduce manufacturing costs.

In the quality request for a coated paper and power saving and manufacturing cost reduction, the trend lies in lower grams per square meter of a base paper and ultra lightweight coating. In manufacturing premises, reformation is strongly invoked for techniques of producing a coated paper for printing having more excellent printing properties while maintaining characteristics of high-speed running ability.

In response to these quality demands, a technique is disclosed that involves, in an offset printing paper to be coated including an undercoat coated layer having a pigment and an adhesive and an overcoat coated layer, containing in a base paper 3 to 20 weight % of a needle or columnar soft calcium carbonate as an internal loading material based on the weight of the base paper, containing in the undercoat coated layer a styrene/butadiene copolymer latex having a gel content of from 75 to 90 weight % and having an average particle diameter of from 40 to 70 mm, and containing in the overcoat coated layer a styrene/butadiene copolymer latex having a gel content of from 40 to 70 weight % and having an average particle diameter of from 40 to 80 mm (Patent Document 1). Also disclosed is a process of producing a to-be-coated paper for applying a coating liquid having a pigment and an adhesive to a paper base, in which a wet paper is water-squeezed using a shoe press in a press part of a base paper machine, the dried base paper and/or undercoat coated paper produced by applying a coating liquid to the base paper is treated by means of a soft calender constituted by a metal roll and an elastic roll at a metal roll surface temperature of from 40 to 90° C at a linear pressure of from 30 to 150 kg/cm, and then a coating liquid having a pigment and an adhesive is applied thereto (Patent Document 2).

However, the re-examination of the formulation of a coated layer, improvement by means of a press part, or the like is a simple extension of prior art. Even if the technique improves print visual quality, operability and productivity in production premises are not improved, and thus, such a technique is not a basic solution.
Patent Document 1: Japanese Patent Application Laid-Open No. 11-279992
Patent Document 2: Japanese Patent Application Laid-Open No. 11-001891

### DISCLOSURE OF THE INVENTION

### Problems to be Solved by the Invention

Therefore, a primary problem of the present invention is to increase productivity and also produce a coated paper with quality required for a coated paper, while a basis weight of a product is decreased to less than 64 g/m² and ultra lightweight coating is performed attributable to reduction in recent paper cost.

Another problem is to obtain a coated paper of good print visual quality having a glossiness of 55% or more, more desirably 60% or more. Still another problem is to be capable of producing a coated paper with high productivity while coping with environmental problems even if a waste paper has a high blend degree of 10% or more. Further problems will be clarified by descriptions below.

### Means for Solving the Problems

The present invention having solved the above problems is as described below.

A process for producing a coated paper in which continuous steps are incorporated successively within on-machine, the process comprising:

a step of making a paper with a twin wire former in which a paper material is injected from a head box between two wires each of which loops to form a paper layer;

an undercoating step of applying an undercoating liquid to a dry web by a size press;

a step of drying the undercoating liquid a first flattening treatment step of performing a flattening treatment by a pre-calender;

a face coating step of applying a face coating liquid by selecting a single coating step of (1) or (2) as follows, or a coating step of performing the step (2) after performing the step (1),

(1) a roll coater coating step of roll-coating one side and the other side of a paper to be coated with an aqueous coating liquid consisting mainly of an adhesive and a pigment, and then drying the coated paper,

(2) a blade coater coating step of blade-coating one side and the other side of a paper to be coated with an aqueous coating liquid consisting mainly of an adhesive and a pigment, and then drying the coated paper; and

a step of subjecting the coated paper to a flattening treatment using a heat soft calender comprising a combination of a metal roll and an elastic roll formed in a multi-stage having at least two nips.

In the process for producing a coated paper of the present invention, the pre-calender comprises a heated metal roll as at least one roll of a pair of rolls.

Furthermore, in the process for producing a coated paper of the present invention, the pre-calender comprises a pair of a metal roll and an elastic roll and the metal roll is heated to a temperature of 100 to 300° C.

In the process for producing a coated paper according to the present invention, the flattening treatment is performed by the pre-calender comprising the metal roll heated to a temperature of 230° C. or more.

Furthermore, the present invention provides a coated paper that is produced by the process described above.

The coating apparatuses include a size press, a calender sizing, a wire bar, an air knife coater, a roll coater (gate roll coater or the like: a coating system of transferring a coating liquid using a roll), a blade coater (bill blade coater or the like: a method of removing a coating liquid with a blade to form a coated layer) and a spray. In Europe many apparatuses are run using a roll coater due to production efficiency priority, and in Japan blade coaters are run due to quality priority.

However, there are no precedents for a process for producing a coated paper constituted by a combination of different coating apparatuses and for a coated paper, which are proposed by the present invention. Further, there is no example of finally flattening a surface of a coated layer by means of a flattening apparatus including a metal roll and an elastic roll.

A coated paper is actively produced using a similar kind of roll coater or blade coater. However, a combination of different coating apparatuses, for example, a combination of a roll coater and a blade coater, makes its apparatus structure complicated and requires diverse knowledge also from the viewpoint of maintenance, and thus has not been adopted.

In a coated paper manufacturing facility including a combination of blade coaters of the same type, the facility flow becomes very long and needs wide placement space. In the production of a coated paper having low grams per square meter and a high blend of waste paper also, the problem of frequent paper breakage-affected by a blade touch pressure occurs due to a problem of a decrease in paper strength, at a high speed paper making, for example, a speed exceeding 1300 m/min. Although there are some measures of restraining a paper making speed and a blade touch pressure, the production efficiency is worsened and the adjustment of a coating amount become difficult.

Although needing few placement space, a combination of roll coaters of the same type makes the smoothness of a coated face inferior to that by a blade coater because of coating by transfer from a roll, thereby being incapable of satisfying a demand of high glossiness and high printing suitability.

A brief comparison between roll coating and blade coating makes clear their superiority and inferiority from a correlation between the coating amounts per face. In other words, at 8 g/m² or more, blade coating is superior in coating properties and smoothness, while roll coating readily makes the surface lips and dips depending on the lips and dips of a base paper and thus is inferior. On the other hand, at 6 g/m²or less, blade coating tends to render the lip portion of the base paper to be exposed only when a coating liquid is placed within the dip portion and thus is inferior, while roll coating is superior in coating properties. In addition, basically regardless of the amount of coating, the case of blade coating is high in the ratio of paper breakage (the higher the speed or the larger the amount of a waste paper blended, the more apparent the trend), while the case of roll coating is low in the ratio of paper breakage. Even at a small amount of coating of 6 g/m² or less, the use of clay with a high aspect ratio, for example, delaminated clay (thin planar crystal structure clay), which obtains high coating properties and gross as a pigment, increases the viscosity during high speed coating. For this reason, roll coating is more suitable. In roll coating, when the amount of coating becomes 8 g/m² or more, the profile in the width direction is difficult to control and also a so-called orange peel pattern is generated, so that face feel and the adhesion of ink become inferior. On the other hand, blade coating generally does not pose such problems. Blade coating enables high concentration coating of, for example, a coating concentration of 65% or more, while roll coating requires the coating concentration to be 56% or less. Thus, drying energy cost per kilogram of paper is lower in blade coating.

As such, roll coater coating and blade coater coating indicated different trends.

For manufacturing a coated paper, including foreign countries and Japan, an off-machine coater in which a paper making machine and a coating machine are separated from each other and an on-machine coater in which a coating machine is incorporated into a paper making machine are known. For an off-machine coater, a paper is generally passed through a size press at a paper making stage. Passing a paper through a pre-calender is not implemented so long as the inventor knows. In the case of an on-machine coater, passing a paper through a size press is conducted in few cases. Instead, passing a paper through a pre-calender device is carried out (an apparatus including the both does not seem to exist).

In particular, in a coating apparatus using an off-machine, a coating base paper of a low basis weight poses a large problem of paper breakage during splicing by auto-splicer.

An auto-splicer is an apparatus that carries out paper splicing without stopping a coater for the purpose of production efficiency improvement. Since the paper splicing section forms a lip portion constituted by adhesion means such as an adhesion tape disposed between pieces of base paper, paper breakage is unlikely generated at a coating speed of 1000 m/min or less. However, at a speed exceeding 1000 m/min, particularly a speed exceeding 1300 m/min, a fine deviation of a winding rotational tuning speed as well as paper breakage by contact of a paper splicing section with a doctor blade edge are readily generated.

For the improvement of paper breakage, measures of improving the tensile strength of the base paper itself are adopted. According to the knowledge of the inventor, however, at least the tensile strength (MD) needs 3.0 kN/m or more. In a waste paper of low grams per square meter obtained by highly blending a waste paper having a low tensile strength, measures such as internal addition of a large amount of a paper strength additive are required, and therefore a large increase in cost is unavoidable.

In coating by an on-machine, an auto splicer is unnecessary and the strength of the base paper itself can be also set low. In the present situations, however, the running speed (not a design speed) is at most about 1200 m/min.

Trying to obtain a higher paper making speed (running speed) exceeding 1300 m/min requires a tensile strength (MD) of 2.6 kN/m or more. In coating by an on-machine, particularly for a high blend of waste paper, as in an off-machine, measures such as internal addition of a paper strength additive are needed, and therefore an increase in cost is unavoidable.

Different from a waste paper consisting essentially of a virgin pulp, a recent waste paper in which a waste paper pulp is largely blended exhibits a remarkable tensile strength decrease and prominent foreign matter (contaminants) mixing. In the case where coating is carried out in a basis weight of paper of about 30 to about 45 g/m² at a speed of 1000 m/min, particularly at a speed exceeding 1300 m/min, the problem of paper breakage is always created.

Paper breakage in a blade coater is liable to occur by pushing pressure by a blade. In particular, since paper breakage by an on-machine stops a series of apparatuses from a paper making machine to a coating apparatus, decreases in production loss and production efficiency are extremely large. Thus, in the present situations, the production of a coated paper of low grams per square meter is generally implemented by coating by an off-machine.

The present inventors have found out a technique capable of providing a coated paper having good print visual quality with low grams per square meter and high blending of waste paper by use of a high speed paper machine, which is an object of the present invention. The coated paper is provided firstly by forming at least two coated layers on a surface of a base paper by use of a coating apparatus comprising a combination of different coating apparatuses, preferably a combination of a roll coater and a blade coater as means for forming coated layers on a surface of a base paper, and secondly by flattening the surface of the coated layer by a combination of a metal roll and an elastic roll. This has lead to the completion of the present invention.

The present invention can continuously perform a coating step passing through a step of making paper and applying an undercoating liquid of starch or the like onto a dry paper web by size press and through a step of performing a flattening treatment on the resulting web by a pre-calender device.

The coating step is a coating step of selecting a single coating step of (1) or (2) as follows, or a coating step of performing the step (2) after performing the step (1).

(1) A roll coater coating step of roll-coating one side and the other side of a paper to be coated with an aqueous coating liquid consisting mainly of an adhesive and a pigment, and then drying the coated paper.

(2) A blade coater coating step of blade-coating one side and the other side of a paper to be coated with an aqueous coating liquid consisting mainly of an adhesive and a pigment, and then drying the coated paper.

Thereafter, the paper to be coated is subjected to a flattening treatment using a heat soft calender comprising a combination of a metal roll and an elastic roll formed in a multi-stage having at least two nips.

The selection of the coating step can be carried out, in one line, according to, for example, base paper grams per square meter, the presence or absence of waste paper, the amount of waste paper blended, the amount of coating, the line speed, product grams per square meter, glossiness to be required, and qualities of smoothness and the like. This makes it possible to commonly produce an ultra lightweight coated paper, a fine coated paper, an A3 coated paper, and an A2 coated paper as required. Although these classifications are not clear for those skilled in the art, for example, a blade coater can be used for an A3 coated paper of 64.0 g/m² or 60.2 g/m² or more, a blade coater or a roll coater for a fine coated paper of 58.0 g/m²or 54.2 g/m², and a roll coater for a lightweight coated paper of 51.2 g/m² or less.

A first feature of the present invention is to incorporate into an on-machine coater a step of coating an undercoating liquid of starch or the like using a size press and a step of performing a flattening treatment by a pre-calender.

Implementation of undercoating of starch by a size press enables the rigidity and paper strength by the starch to be increased and enables the prevention of paper breakage also by lower grams per square meter of a base paper or high blending of a waste paper (in particular, in the case of blade coating) as well as restrains the protrusion of contaminants and contributes to flattening of a subsequent coating liquid.

Subsequently, a flattening treatment is desirably performed by a pre-calender. A pre-calender contributes to the flattening and also, in particular, to homogenization of the profile in the width direction after the subsequent coating step. That is, the flattening treatment serves to homogenize the surface of a paper onto which an undercoating liquid of starch or the like has been applied. In particular, where a target paper width is 7000 mm or more, the profile in the width direction after coating is greatly broken, while the implementation of the flattening treatment by a pre-calender can homogenize the surface. In particular, subsequently, in the case where coating of 8 g/m² or more is carried out by a roll coater, profile control in the width direction is difficult by a roll coater, while the adoption of a pre-calender enables the homogenization of the profile in the width direction. In addition, in the case where blade coating is performed for the homogenization of the surface in the width direction, a pre-calender uniforms the touch of a blade and thereby also contributes to the prevention of paper breakage.

A second feature is that the invention is that the selective coating step or apparatus described above is provided. The advantage of this respect has been described previously and thus is not described again.

A third feature is inclusion of a step or apparatus for performing a flattening treatment using a heat soft calender comprising a combination of a metal roll and an elastic roll formed in a multi-stage having at least two nips. In particular, 6-stage, more preferably 8-stage (7-nip) or 10-stage multi-nip calender is most appropriate.

With a lower coating amount, flattening properties and glossiness become difficult to secure. On the other hand, the inclusion of a step of flattening treatment of the present invention enables a coated paper having a target glossiness of 55% or more, particularly 60% or more to be obtained, for example, even in the case where the coating amount is 7 g/m² or less, particularly 6 g/m² or less, the product grams-per square meter is less than 54.2 g/m² and the base paper grams-per square meter is 45.0 g/m² or less.

Although disposing a (heat soft calender) multi-nip calender itself is well-known, adoption examples are not so many. Needless to say, a combination of undercoating for coating by a size press and a pre-calender is just a beginning for any of off-machines and on-machines. These combinations according to the present invention enable even the production of ultra lightweight coated paper of 51.2 g/m² or less from the viewpoint of the provision of high smoothness and high glossiness.

After the implementation of coating by a roll coater, it is possible to carry out coating by a blade coater. As described previously, in the case by a roll coater, coating properties of paints are good even in a low coating amount. Then, first, when coating is carried out by a blade coater after implementation of coating by a roll coater, a second coating layer is coated by a blade coater excellent in smoothness on a first coating layer exhibiting good coating properties. For this reason, even if a low coating amount (ultra lightweight coat) of 6 g/m² or less as the total coating amount or a coating amount of about 7 to 9 g/m² per face is used, a coated paper can be obtained that is excellent in coating properties, smoothness and glossiness.

Moreover, the first coating layer is allowable if the coating properties can be secured, so that a high quality coating liquid is not required to be used. Hence, an advantage is that a coating liquid at a low cost is coated by a blade coater to be capable of forming a high quality coating layer.

Furthermore, disposing a size press enables undercoating of starch or the like, and also enables the use of a pigment and an adhesive for coating.

The present invention enables the production of an ultra lightweight coat paper of low grams per square meter at a paper making speed of 1300 m/min or more or exceeding it, particularly at a running speed of 1550 m/min or more, at from 1600 m/min to 1800 m/min. When the running speed becomes 1300 m/min or more, the mode of technical problems for quality to be demanded is completely changed compared with the case of a running speed of 1300 m/min or less, a running speed of 1200 m/min that is presently regarded as a high speed. Needless to say, for an on-machine coater, problems that are difficult to solve are extremely many.

With a base paper of the present invention, a paper material is ejected from a head box into between two wires that each make loops to form a paper layer. For example, the base paper is subjected to a size press, after passing through a step of making a paper using a twin wire former of a cap type and a step of forming a wet paper by dewatering means using a suction (forming) roll and/or a blade in a wire part. The base paper that is made using a twin wire former of a cap type preferably has sufficient paper strength even in low grams per square meter.

Application of starch by a size press can further improve paper strength.

Furthermore, the improvement of flattening properties of the base paper surface (particularly, in the width direction) by a pre-calender makes it possible to have sufficient paper strength and flattening properties even if a touch pressure of a blade is high, but not leading to paper breakage, in a coating apparatus. After coating, flattening treatment at a high speed and a high temperature by means of a multi-stage multi-nip calender comprising an elastic roll and a metal roll can obtain flattening properties and high glossiness of the surface of the coating layer.

The present inventor has found that disposing a size press and further a pre-calender in a pre-step of a roll coater is extremely effective means for solving print visual quality failure and damage generation and improving printing and glossiness unevenness due to coating profile unevenness that is a specific problem of a roll coater in low grams-per square meter, in order to cope with technically demanded, low grams-per square meter and high blending of a waste paper that is friendly to the environment and to obtain high quality good look printing suitability and glossiness.

Additionally, in a coating liquid by size press, a surface sizing agent, an antifoaming agent, an antiseptic, a thickener, etc., which are usually as required used, are used together as appropriate.

Moreover, it is necessary to perform a flattening treatment to a paper at high temperature without paper break in order to obtain evenness and glossiness of the surface of a coated paper while maintaining rigidity required in printing suitability, i.e., stiffness of paper. A conventionally generally adopted fattening treatment using a plurality of stacks not only needs placement space, but is difficult to make an apparatus high temperature and is extremely bad in flattening efficiency to a base paper. For this reason, it is impossible to increase a paper making speed in order to obtain evenness and glossiness with maintenance of rigidity while substantially avoiding paper breakage, thereby having to perform the production at a sheet making speed of 1200 m/min or less.

A more preferred aspect of the present invention includes a flattening apparatus comprising a combination of a metal roll and an elastic roll in the present invention, for example, a combination with a multi-nip calender. As a still more preferred aspect of a multi-nip calender, a jacket roll is applied to a metal roll of a multi-nip calender. A multi-nip calender includes a combination of a metal roll and an elastic roll in a multi-stage. Each nip pressure per roll is individually increased to about 450 kN/m. Making the number of rolls 6 to 12 stages sufficiently enables a flattening treatment even to a paper making speed of 1300 m/min or more and further even a high speed coating of 1600 m/min or more.

In some cases, each interval between rolls is opened with one to two nips closed, and a coated paper of a mat pattern can be also produced. However, a flattening treatment with a roll number of 6 to 12 stages can obtain a coated paper of a white paper glossiness of 55% or more, particularly 60% or more, even at a high speed paper making speed of 1300 m/min.

### ADVANTAGES OF THE INVENTION

According to the present invention, a brilliant high-quality coated paper can be produced at a high production efficiency even for a base paper with low grams per square meter and high blending of a waste paper. The advantage of the present invention is clarified by examples and comparative examples that have been diligently studied for a long period of time and are described below.

A high quality coated paper excellent in glossiness, smoothness, printing suitability, etc., can be produced, with extremely good operationability being secured, in high speed paper making at a paper making speed of exceeding 1300 m/min by means of a process for producing a coated paper according to the present invention using paper making equipment (online machine) integratedly from a paper raw material to a product.

The present invention is intended to produce, for example, a coated paper or ultra lightweight coated paper having 10% or more of a waste paper blended in its raw material as a raw material pulp, with paper grams per square meter of from 28 to 80 g/m² (particularly from 35 to 48 g/m²), product grams per square meter of from 30 to 103 g/m² (particularly from 35 to 64 g/m²) and a one-side coating amount of from 2 to 23 g/m² (particularly from 4 to 9 g/m²) continuously and integratedly from paper making to winding at a paper making speed of 1300 m/min or more, for example, at a high speed of an average paper making speed of from 1600. m/min to 1800 m/min. In addition, desirably, the coating amount is from 2 to 10 g/m² (particularly from 5 to 7 g/m²) at one side in roll coating, and from 6 to 15 g/m² (particularly from 7 to 9 g/m²) at one side in blade coating. Usually, both-face coating is desirably carried out, and thus the amount is twice the above one-side coating amount.

The present invention can make the number of operators smaller. In re-reeler equipment of re-reeling and off-calender requiring running termination and paper joining, a total of 16 operators (4 groups (each 4 operators) and three shifts) are generally required. However, the present invention can remove the 16 operators.

### BEST MODE FOR CARRYING OUT THE INVENTION

Next, a best mode for carrying out the present invention will be described with reference to the drawings and further the present invention will be set forth in detail.

Referring to FIG. 1, a paper making machine is placed in which a paper is made by a gap type twin wire former 10 for forming a paper layer by ejecting a paper material J from a head box 3 into between two wires (a first wire 1 and a second wire 2) each of which loops. The paper material J is ejected into between a suction (forming) roll 4A and a roll 4B facing each other and between the wires in the wire part thereby to form a paper layer. The paper layer is dewatered to, for example, about a raw material concentration of about 20% while passing through the suction (forming) 4A, a blade 5, a suction couch roll 6, a suction box 7, etc.

Here, a combination use form of roll means and blade dewatering means in the illustration shown is indicated as a dewatering mechanism, and preferably the both are used, but only one is possibly used.

The head box 3 is in a vertical or downstream inclined state and upward disposed. As enlargedly shown in FIG. 6, an ejection angle θ which the paper material ejection direction line makes the horizontal line is desirably from 50° to 90°. In high speed paper making intended by the present invention, an upward head box in which the influence of the fiber weight is small is desirable from the viewpoints of texture, the Z axis strength, front and back difference, fiber orientation angles, etc. In a gap type twin wire former, when the head box is horizontal or the like, desirable properties are difficult to obtain in high speed paper making.

A paper layer in the wire part moves to the press part and further dewatered. The press part in an embodiment, in which a first press 21 and a second press 22 respectively have shoe presses 21a, 22a, is made to be a configuration in which a paper layer is straightly nipped to remove open draw and prevent paper breakage. In addition, a belt in the second press 22 is placed on the bottom side relative to the first press 21 of a double felt, and the press is configured so as to prevent wetting again and improve dewatering. Where the basis weight is as high as 60 g/m² or more and the amount of dewatering is large, a double felt is desirable.

A wet paper of a moisture of about 50% having passed through the press part, as referred to FIG. 2, moves to a pre-dryer part of a single deck system and is dried. An illustrated dryer part is a single deck dryer of no open draw system and is configured so as to include an appropriate number of rolls, with the upper side being a heating roll 31 and the lower side being a vacuum roll 32. A single deck dryer has little paper breakage in high speed paper making at 1300 m/min or more that is a target of the present invention, can perform drying at a high efficiency and is excellent in quality and operation. Although a system can be taken into account in which a double deck system is used for drying, it poses problems from the viewpoints of operation properties such as canvas marks in high speed paper making, paper breakage in high speed drying, cockles and paper joining.

In the initial period in a dryer, desirably, partitioned groups are made many for draw adjustment and a suction box 33 is disposed for improvement of air passing through paper and sheet traveling.

A paper web dried in the pre-dryer part, as shown in FIG. 3, is coated with a sizing agent such as starch and, as required, an undercoating liquid such as a pigment coating liquid in a size press 40 of a film transfer (system) between the pre-dryer part and an after dryer part. The size press 40 accepts a gate roll coater 40A or the like, in addition to an illustrated rod metaling size pre-coater.

The undercoating liquids that can be used include, besides starch as mentioned above, starch derivatives such as oxidized starch, estrified starch, enzyme-modified starch and etherified starch, and natural adhesives such as soy bean protein, yeast protein and cellulose derivatives. As required, a pigment may be added thereto. The pigments include kaolin, clay, barium sulfate, light calcium carbonate, heavy calcium carbonate, aluminum hydroxide, satin white, titanium dioxide, calcium sulfite, zinc sulfate, and plastic pigments. The pigment, a usual pigment for a coated paper, is blended depending on respective pigment properties. Moreover, the adhesives that can be used include usual additives for a coated paper including synthetic resin adhesives such as alkali non-sensitive or alkali sensitive synthetic resin emulsions, for example, conjugated diene copolymer latexes such as styrene/butadiene copolymers and methylmethacrylate/butadiene copolymers, acrylic polymer latexes such as polymers or copolymers of acryl and/or methacrylate esters and vinyl acetate copolymer latexes such as ethylene/vinyl acetate copolymers. As required, a variety of assistants can be blended that include a dispersing agent, a flow-modified agent, an antifoaming agent, a dye, a lubricant, a water resistant additive and a water retention agent. The coating amount of a base coating agent is preferably from 0.01 to 4 g/m², particularly preferably from 0.2 to 3 g/m².

Examples of the coating means of a film transfer system that can be used include a gate roll coater, a sim sizer, and a blade metaling size press or a rod metaling size press. Particularly desired is a rod metaling size press. When this rod metaling size press coater is employed, a rod having a smooth surface is desirably used to avoid streak generation in operation. Setting the rod diameter to be from 15 to 50 mm can obtain more preferable operation properties and quality. A rod having a diameter of less than 15 mm is liable to lead to decreasing in film forming capability and becoming inferior in surface. For a rod having a diameter of more than 50 mm, the effect is not changed, and thus a particularly large diameter is not required. A rod with a groove, a rod winding a wire therearound, or the like can be also used as the rod.

After coating of an undercoating liquid, an auxiliary drying device 42 using an air turn bar 41 and an infrared ray is desirably disposed in advance in an after dryer part in order to avoid the generation of surface dirt.

In the illustrated after dryer part of a single deck, a sizing agent and a pigment coating liquid are dried.

Thereafter, in a coater part, an aqueous coating liquid having an additive and a pigment (clay or the like) as primary components is applied. In this case, roll-coating an aqueous coating liquid is adopted from the viewpoint of the quality of the resulting coated paper because a flat coated layer is required, at a paper making speed of 1300 m/min or more so as not to generate paper breakage and not to generate paper breakage in a second blade coating apparatus.

As such, prior to roll coating of an aqueous coating liquid, a surface coated with a sizing agent is desirably flattened by a pre-calender 50 in order to secure higher smoothness. The pre-calender 50 of the embodiment has a metal roll 51 on an upper side and an elastic roll 52 on a lower side.

In operation conditions in the pre-calender 50, a heat roll instead of a metal roll is desirable. Desirably, the temperature is set at, for example, from 100 to 300° C., particularly from 150 to 250° C., and the linear pressure is set at 50 KN/m. Both the rolls can be metal rolls and further a caliper control roll can also be used in order to control the profile in the width direction.

A coater part of the present invention subsequent to the pre-calender 50 has a first roll coating step to both the faces of a paper to be coated and a second blade coating step to both the faces of a paper to be coated and selectively carries out coating.

In other words, when passed through the first roll coating step, the paper to be coated is coated on its both faces by a roll coater 60. After passed through an air turn bar 61, the resulting paper, in the width direction, is dried by a temperature controllable auxiliary drying device 62 using an infrared ray (having the same function as in other cases), a first gas-type air dryer 63A, an infrared ray auxiliary drying device 63A, an infrared ray auxiliary drying device 67A and a first canvas dryer 64. Thereafter, the resulting paper is passed through a bypass pathway Y, dried by a second canvas dryer 68, and then led to a calender 70.

Where passed through the second blade coating step, the paper is passed through the pre-calender 50 and then through a bypass pathway X. The paper is, without being passed through the roll coater, directly led to a first blade coater 65A, where one face of the paper is coated. After coated, the paper is dried by an infrared ray auxiliary drying device 66A, the first gas-type air dryer 63A, the infrared ray auxiliary drying device 67A and the first canvas dryer 64.

Thereafter, the paper is, without being passed through the bypass pathway Y, led to a second blade coater 65B, where the other face is coated. After coated, the resulting paper is dried by an infrared ray auxiliary drying device 66B, a second gas-type air dryer 63B, an infrared ray auxiliary drying device 67B and the second canvas dryer 68, and led to a calender 70.

Where, the paper to be coated is subjected to lower layer coating on its both faces by the roll coater 60 via a bypass pathway Z and can also be subjected to upper layer coating by use of the first blade coater 65A and the second blade coater 65B.

The above-mentioned infrared ray auxiliary drying devices can be used for temperature control in the width direction in order to mainly each adjust moisture contents, and their adoption can be selected as appropriate.

In the first blade coater 65A and the second blade coater 65B, a coating amount of 7 g/m² or more per face may be required in the case of high speed paper making. In such a case, a jet fountain system capable of making high speed liquid provision as an applicator is desirable and raking off is made by a blade. When a coating amount of less than 7 g/m² for one face is required, a short dwell blade coater improved for high speed is also acceptable.

In blade coating, as shown in FIG. 10, a fountain angle a of an applicator 90 in the case where the coating of a jet fountain system is adopted from 30 to 90 degrees, more desirably from 40 to 60 degrees, in order to remove coating unevenness in the flow and width directions for roll coating. When the fountain angle a is out of the above range, a rough surface and coating unevenness are generated. A system having a bevel angel 0 of from 30 to 50 degrees in a blade edge is desirable. The thickness of a blade is desirably from 0.45 to 0.60 mm. For the possession of a high hardness, the blade edge is constituted by a thermal spraying material having tungsten or alumina oxide as a primary component. For example, a system, having excellent conditions in coating properties, has a constitution produced by thermally spraying tungsten to a base material making up the edge of a blade and has a Vickers hardness of from 1000 to 1700 Hv.

In this case, after blade exchange, cooling means such as water shower cooling is desirably disposed to prevent blade burning at a high speed paper making at a time of new blade touch.

Finally, an on-machine calender 70 constituted by a thermal soft calender is disposed and calender treatment is implemented. The illustrated calender 70 is a multiple calender of one stack type of 9 nips of vertical placement of an optiload type. One stack type of 7 nips can also be used and also Janus type inclined placement, illustrated together, that makes the influence of roll dead weight small is allowable.

The calender 70 affects final smoothness and glossiness. Hence, a variety of considerations are required in terms of this and high speed paper making.

The number of stages of the calender 70 is not limited so long as the calender has at least two nips, and a flattening treatment is desirably implemented by a thermal soft calender comprising a combination of a metal roll M and an elastic roll D formed in a multi-stage. In particular, a multi-nip calender, more desirably a multi-nip calender of 6, 8 or 10 stages is most suitable.

On the other hand, a thermal calender may be a calender in which a thermal medium such as oil is circulated and heated, but this has a limit of a surface temperature of about 180° C. For the implementation of paper making at a high speed, as shown in FIGS. 7 to 9, the metal roll M includes an internal heating device having electromagnetic induction action capable of split temperature control in its width direction, and treatment is desirably carried out at a surface temperature of the metal roll M of 230° C. or more, particularly from 230 to 500° C. A specific example is a roll in which an induction coil 71 is wound around an iron core 72 within a shell 74 and a heat medium passed through a jacket chamber 73 is heated.

A surface treatment is performed at a temperature of from 250° C. to 380° C. of the metal roll M, particularly at a temperature of from 300° C. exclusive to 380° C. inclusive, and a paper is not broken throughout the entire layer at as low a nip pressure as possible to be capable of preventing a decrease in bulk and of restraining a decrease in opacity, whereby operation can also be implemented. In short, it is a mode in which an iron at an extremely high temperature is contacted for a short time.

The methods of controlling the surface temperature of a metal roll that are particularly excellent for elevated temperature treatment of the present invention include, in addition to a method of circulating hot water or oil into a metal roll, as described above, a method by an “internal heating device by electromagnetic induction action” that involves disposing an induction coil around an iron core disposed in an inside as a non-rotation portion, flowing an alternating current into its induction coil to generate a magnetic flux in the coil and induce an induction current inside an external shell (external cylinder) as a rotation portion and self heat releasing (induction heat release) the outside shell (external cylinder) by its resistance heat. In addition, according to the internal heating device by the electromagnetic induction action, there is an advantage that an induction coil is divided (e.g., 3 to 6 divisions) in the width direction (longitudinal direction of the roll itself) and an alternating current amount flowed into a corresponding induction coil is controlled based on a temperature signal from a temperature sensor disposed in the shell, so that the temperature control in the width direction particularly on the surface is possible at high precision.

In this case, a structure in which jacket pathways particularly extended in the longitudinal direction inside the shell are disposed in large numbers, from 10 to 90 pathways, in the peripheral direction at intervals, in which these are connected to each other, and in which a heat medium is enclosed in the inside, is more excellent from the viewpoints of heat due to self heat releasing of the shell being absorbed and the heat being uniformed on the entire roll surface.

A surface treatment at elevated temperature according to the present invention increases not only the temperature of the surface layer portion of a paper but the temperature of the inner layer portion. As a result, not only the surface layer portion of the paper but the entire layer is liable to break, so that the bulk is lowered. Therefore, where a paper is passed for a short time by further high temperature treatment, heat transfer to the inner layer portion can be prevented extremely, thereby being capable of preventing a decrease in bulk.

On the contrary, with increased temperature of the surface temperature of a metal roll, the stress in the width direction in the shell of a metal roll is generated and the roll profile is likely to be destroyed, whereby the controlling of a thick paper profile is decreased. In addition, when a metal roll depends on an internal heating device by electromagnetic induction action, the temperature response of the surface temperature of the metal roll per time does not seem to be good. Moreover, due to this, the temperature response in the width direction is bad, which is a cause of yield decrease because of bad temperature controlling. Thus, at least either an external heating device by electromagnetic induction action capable of division temperature control in the roll width direction or a cooling apparatus capable of cooling temperature control in the roll width direction is desirably provided in the vicinity of the metal roll M.

This example will be primarily described in reference to FIG. 8. The metal roll M includes a shell 74, an induction coil 71, an iron core 72, a temperature sensor 75, an alternating current source and a jacket pathway 73. With this metal roll M, an internal heating device 77 by electromagnetic induction action capable of division temperature control in the roll width direction is disposed in the vicinity of the metal roll M to constitute a high temperature nip region of a base paper.

The internal heating device 77 is an application of the principle of electromagnetic induction heating. As shown in the drawing, the internal heating device 77 entails flowing an alternating current (e.g., a high frequency of from 3 to 20 kHz) from an alternating current source (inverter) 77B to a work coil 77A to generate a magnetic field, generating an eddy current on a shell 74 surface portion, and self heat releasing. The separation distance between the work coil 77A and the shell 74 surface is desirably from 2 to 20 mm, particularly desirably roughly from 2 to 5 mm. In addition, a unit work coil is desirably inclination-disposed so as to cross the shaft of the metal roll M for the purpose of texture of a profile for heating purposes. The zone control pitch in the roll width direction is roughly from to 150 mm, and the rating electric power per zone can be set at from 4 to 20 kW.

An example of a cleaning apparatus 78 capable of cooling temperature control in the roll width direction is as follows. As shown in FIG. 9, air is sent from a fan 78a to a header 78b and the air is sent into a temperature adjusting chamber 78d through an adjusting plate 78c having communicated pores formed therein. Then, a coil 78e disposed within the temperature adjusting chamber 78d is cooled by temperature adjusting means 78f to control the ventilation temperature passing through a dispersion plate 78g having small pores.

The nip pressure in the calender 70 is desirably from 200 KN/m to 450 KN/m, particularly desirably from 300 KN/m to 450 KN/m. The paper flattening treated by the calender 70 is finally wound by a reel 80, and a winder (not shown) for finishing winding for subdivision is disposed in the final portion of the machine.

In place of the multi-nip calender shown in FIG. 4, as illustrated in FIG. 5, for example, a soft calender 70A including the metal roll M constituted by 1 nip and 4 stacks and the elastic roll D is acceptable.

### Examples

Advantages of the present invention will be clarified by means of examples and comparative examples.

Factors such as a wire part mode, a placement angle of the head box, a suction mode, a coating mode, a thermal soft calender and a paper making speed, of the present invention, were changed and quality of paper were evaluated. In addition, each of the examples did not newly dispose individual lines for each of all the factors and testing examples by testing plants were primarily newly replaced.

Quality evaluations of paper are in the following. 1. Contaminants: The area of contaminants was evaluated by connecting a CCD camera to an optical microscope and measuring one sheet A4 paper at a magnification of 8 μm per pixel via an image analyzing unit (LUZEX AP) and then averaging them for 10 cm². In addition, contaminants of 0.005 mm² or less could not visually be recognized, and thus were neglected.

2. Texture evaluation: The texture evaluation stipulated in the example was implemented by obtaining the variation of a transmitted light amount as a time sequence signal using a sheet texture tester available from TOYO SEIKI KOGYO CO., LTD. This measuring device can measure 28 points in the wavelength range of unevenness of from about 0.16 to about 80 mm. However, because 14 points in the range of from 4.0 to 80 mm in the example were closely related to texture indicated by large shades in watermark texture by sensory inspection, the sum of the coefficients of variation in the range was determined. When the unevenness index is less than 6%, the texture is very in uniform, the glossiness unevenness of a coated paper surface attributable to texture unevenness hardly occurs, the formation of a coated layer is uniform, and printing unevenness at printing, printing glossiness unevenness, etc. disappear, so that printing suitability is improved.

3. Paper breakage: A test operation was conducted at a paper making speed of 1500 m/min at a constant drying temperature for 3 hours using a test plant equivalent to an actual machine and the number of paper breaks due to the difference of drying methods was evaluated.

◯: Number of paper breaks, 0 time; Δ: one time; X: one or more times.

4. Cockle: A test operation was conducted at a paper making speed of 1300 m/min at a constant drying temperature for 3 hours using a test plant and the number of cockles due to the difference of drying methods was evaluated. ◯: Number of cockles, 0; Δ: one; X: one or more.

5. Specific volume: Measured in accordance with JIS P 8118 (1976).

6. Glossiness: Was measured at an angle of 75 degrees in accordance with JIS P 8142.

7. Glossiness unevenness: Test paper sheets of an A4 size were prepared, and were visually evaluated by five females and five males on the basis of five criteria. Level 3 or higher was regarded allowable.

8. Printing unevenness: Test paper sheets of a duodecimo size were prepared, and printed using a Rowland offset printer, left to stand for 24 hours at a constant temperature. Then, solid printed portions of samples, overprinted with four colors of black, magenta, cyan and yellow, were visually evaluated by five females and five males on the basis of five criteria. Level 3 or higher was regarded allowable.

9. Rigidity: Determined in accordance with JIS P 8115.

10. Yellow change (by calender treatment): A product was prepared to a duodecimo size and the extent of yellow of the product was visually evaluated by five females and five males on the basis of five criteria. Level 3 or higher was regarded allowable.

11. Productivity: stability of a wet end, dewater properties in a press part, generation states of drainage and streaks, etc. in each example in a test machine were observed by five operators, and each of the evaluation results was collected and evaluated based on 5 criteria. Level 3 or higher was regarded allowable.

12. Overall evaluation: All of the quality attributes were all totally evaluated on the basis of four criteria. \textcircled{∘}: Good production efficiency/quality, ◯: No problems in production efficiency/quality, Δ: Some problems, X: Problems.

In addition, the roll hardness of a roll coater is the A hardness value of JIS K 6301, and the hardness of a blade is the Hv (hard Vickers). The roll surface roughness indicates the central line average roughness in accordance with JIS P 0601.

Base paper conditions are as follows:

<Production of Paper Base Material>

A base paper having pulp below and a basis weight (absolute dry) of 60 g/m² was made to produce a paper base material.

<Blending of Pulp>

A pulp was prepared according to the example tables. In the present invention, paper breakage was frequently generated due to the affect of contaminants in high speed paper making. For this reason, a raw material pulp was prepared such that the amount of contaminants in a product was 0.010 mm²/10 cm² or less per A4 size sheet in the measuring amount in contaminant measuring means and used.

A paper base material was prepared using the above pulp blending and the internal additive agent blending below.

<Blending of Internal Additive Agents>
Soft calcium carbonate: 10 weight parts (average particle diameter: 3.4μ, calcite-based)
Commercially available alkylketene dimmer-based internal sizing agent (AKD): 0.03 weight part
Commercially available cationized starch: 0.2 weight part
Commercially available cation-based polyacrylamide yield improving agent: 0.03 weight part

<Size Press>

A starch coating liquid was applied in an amount of 0.5 g/m² onto the above paper base material and dried.

<Production of Coated Paper>

The coating liquid having the blend below was applied onto a paper base material after the above size press using a roll coater and a blade coater according to examples and dried.

<Blending of Overcoating Liquid>

Blending is as follows:

### (Pigments)

Spindle-shaped soft calcium carbonate (TPI121 available from OKUTAMA KOGYO CO., LTD., 3.4 μm): 30 weight parts
Commercially available fine particle kaolin (Amazon 88, average particle diameter: 0.8 μm): 70 weight parts

### (Binders and Additives)

Commercially available phosphoric acid esterified starch (MS4400 available from NIHON SHOKUHIN KAKO CO., LTD.): 1 weight part
Styrene/butadiene latex (0617 available from JSR CORPORATION): 12 weight parts
Commercially available polyacrylic acid-based dispersing agent: 0.1 weight part
Commercially available calcium stearate: 0.3 weight part
Sodium hydroxide: 0.15 weight part

Under the conditions above and the conditions indicated in Tables, a variety of factors were searched and the results listed in Tables 1 to 36 were obtained. Examples 1 to 42 indicate examples of a combination of roll coating and blade coating only, Examples to 56 indicate examples of roll coating only, and Examples 57 to 69 indicate examples of blade coating only.

TABLE 1

| | Wet paper forming step | | | Press part (1 P) | | | | | Pre-calender | Paper |
|---|---|---|---|---|---|---|---|---|---|---|
| | Wire part | Suction mode | | | Felt | Blade dryer | Size press | After dryer | Soft calender | making |
| | mode | 1 Stage | 2 Stage | Mode | constitution | Mode | Mode | Mode | Mode | speed m/min |
| Example 1 | Gap former | Suction | Suction | Shoe | Double felt | Single deck | Gate roll | Single deck | 1 Nip 1 stack | 1300 |
| | | roll | blade | press | | | | | | |
| Example 2 | Gap former | Suction | Suction | Shoe | Double felt | Single deck | Gate roll | Single deck | 1 Nip 1 stack | 1400 |
| | | roll | blade | press | | | | | | |
| Example 3 | Gap former | Suction | Suction | Shoe | Double felt | Single deck | Gate roll | Single deck | 1 Nip 1 stack | 1600 |
| | | roll | blade | press | | | | | | |
| Example 4 | Gap former | Suction | Suction | Shoe | Double felt | Single deck | Gate roll | Single deck | 1 Nip 1 stack | 1800 |
| | | blade | roll | press | | | | | | |
| Example 5 | Gap former | Suction | Suction | Shoe | Double felt | Single deck | Gate roll | Single deck | 1 Nip 1 stack | 1400 |
| | | roll | roll | press | | | | | | |
| Example 6 | Gap former | Suction | Suction | Shoe | Double felt | Single deck | Gate roll | Single deck | 1 Nip 1 stack | 1600 |
| | | blade | blade | press | | | | | | |
| Example 7 | Gap former | Suction | Suction | Shoe | Double felt | Single deck | Gate roll | Single deck | 1 Nip 1 stack | 1400 |
| | | roll | blade | press | | | | | | |
| Example 8 | Gap former | Suction | Suction | Shoe | Double felt | Single deck | Rod | Single deck | 1 Nip 1 stack | 1600 |
| | | roll | blade | press | | | metaling | | | |
| Comparative | Gap former | Suction | Suction | Press | Single felt | Double deck | — | Single deck | 1 Nip 1 stack | 1000 |
| Example 1 | | roll | blade | | | | | | | |
| Comparative | Gap former | Suction | Suction | Press | Single felt | Double deck | — | Double | — | 1100 |
| Example 2 | | roll | blade | | | | | deck | | |
| Comparative | Long net | Suction | — | Shoe | Double felt | Single deck | — | Single deck | — | 1200 |
| Example 3 | | blade | | press | | | | | | |
| Comparative | Gap former | Suction | — | Press | Single felt | Single deck | — | Double | — | 1400 |
| Example 4 | | roll | | | | | | deck | | |
| Comparative | Long net | Suction | — | Shoe | Double felt | Single deck | — | Double | — | 1100 |
| Example 5 | | blade | | press | | | | deck | | |
| Comparative | Gap former | Suction | Suction | Press | Single felt | Double deck | — | Double | — | 1100 |
| Example 6 | | roll | blade | | | | | deck | | |
| Comparative | Gap former | Suction | Suction | Press | Single felt | Double deck | — | Double | 1 Nip 1 stack | 1100 |
| Example 7 | | blade | roll | | | | | deck | | |

TABLE 2

| | First coating apparatus | | | | |
|---|---|---|---|---|---|
| | | Hardness | Roll surface roughness | | Coating amount |
| | Coater mode | Hv | μm | Material | Both faces g/m² |
| Example 1 | Roll | 70 | 5 | Urethane coated roll | 10 |
| Example 2 | Roll | 75 | 5 | Polyether resin coated roll | 10 |
| Example 3 | Roll | 80 | 5 | Polyethylene blended urethane roll | 10 |
| Example 4 | Roll | 85 | 5 | Urethane coated roll | 10 |
| Example 5 | Roll | 90 | 5 | Polyethylene blended urethane roll | 10 |
| Example 6 | Roll | 80 | 10 | Urethane coated roll | 10 |
| Example 7 | Roll | 80 | 5 | Urethane coated roll | 10 |
| Example 8 | Roll | 80 | 2 | Urethane coated roll | 10 |
| Comparative Example 1 | Blade/blade | 1100 | — | Tungsten | 10 |
| Comparative Example 2 | Blade/blade | 1100 | — | Alumina oxide | 10 |
| Comparative Example 3 | Roll | 70 | 5 | Urethane coated roll | 10 |
| Comparative Example 4 | Blade/blade | 900 | — | Tungsten carbide | 10 |
| Comparative Example 5 | Roll | 70 | 5 | Urethane coated roll | 10 |
| Comparative Example 6 | Blade/blade | 1400 | — | Tungsten | 10 |
| Comparative Example 7 | Blade/blade | 1100 | — | Tungsten | 10 |

TABLE 3

| | Second coating apparatus (Front) | | | | | | |
|---|---|---|---|---|---|---|---|
| | | | | Thickness | Hardness | | Fountain angle |
| | Coating mode | Mode | Material | mm | Hv | Bevel angle | Degree |
| Example 1 | Jet fountain | Blade | Tungsten | 0.6 | 1400 | 40 | 50 |
| Example 2 | Jet fountain | Blade | Tungsten | 0.6 | 1400 | 40 | 50 |
| Example 3 | Jet fountain | Blade | Tungsten | 0.6 | 1400 | 40 | 50 |
| Example 4 | Jet fountain | Blade | Tungsten | 0.5 | 1000 | 30 | 50 |
| Example 5 | Jet fountain | Blade | Tungsten | 0.7 | 1400 | 50 | 50 |
| Example 6 | Jet fountain | Blade | Tungsten | 0.5 | 1600 | 40 | 50 |
| Example 7 | Jet fountain | Blade | Alumina oxide | 0.6 | 1400 | 40 | 45 |
| Example 8 | Jet fountain | Blade | Tungsten | 0.6 | 1400 | 40 | 60 |
| Comparative | Jet fountain | Blade | Tungsten | 0.4 | 900 | 40 | 25 |
| Example 1 | | | | | | | |
| Comparative | Jet fountain | Blade | Tungsten | 0.5 | 900 | 40 | 25 |
| Example 2 | | | | | | | |
| Comparative | Applicator roll | Roll coater | — | — | — | — | — |
| Example 3 | | | | | | | |
| Comparative | Jet fountain | Blade | Tungsten | 0.5 | 900 | 40 | 25 |
| Example 4 | | | | | | | |
| Comparative | Applicator roll | Roll coater | — | — | — | — | — |
| Example 5 | | | | | | | |
| Comparative | Jet fountain | Blade | Tungsten | 0.4 | 1500 | 65 | 50 |
| Example 6 | | | | | | | |
| Comparative | Jet fountain | Blade | Tungsten | 0.5 | 900 | 40 | 25 |
| Example 7 | | | | | | | |

TABLE 4

| | Second coating apparatus (Back) | | | | | | | Coating amount |
|---|---|---|---|---|---|---|---|---|
| | | | | | | | Fountain | Product coating |
| | | | | Thickness | Hardness | Bevel | angle | amount |
| | Coating mode | Mode | Material | mm | Hv | angle | Degree | g/m² |
| Example 1 | Jet fountain | Blade | Tungsten | 0.6 | 1400 | 40 | 50 | 24 |
| Example 2 | Jet fountain | Blade | Tungsten | 0.6 | 1400 | 40 | 50 | 24 |
| Example 3 | Jet fountain | Blade | Tungsten | 0.6 | 1400 | 40 | 50 | 24 |
| Example 4 | Jet fountain | Blade | Tungsten | 0.5 | 1000 | 30 | 50 | 24 |
| Example 5 | Jet fountain | Blade | Tungsten | 0.7 | 1400 | 50 | 50 | 24 |
| Example 6 | Jet fountain | Blade | Tungsten | 0.5 | 1600 | 40 | 50 | 24 |
| Example 7 | Jet fountain | Blade | Alumina | 0.6 | 1400 | 40 | 60 | 24 |
| | | | oxide | | | | | |
| Example 8 | Jet fountain | Blade | Tungsten | 0.6 | 1400 | 40 | 45 | 24 |
| Comparative | Jet fountain | Blade | Tungsten | 0.4 | 900 | 40 | 25 | 24 |
| Example 1 | | | | | | | | |
| Comparative | Jet fountain | Blade | Tungsten | 0.5 | 900 | 40 | 25 | 24 |
| Example 2 | | | | | | | | |
| Comparative | Applicator roll | Roll coater | — | — | — | — | — | 24 |
| Example 3 | | | | | | | | |
| Comparative | Jet fountain | Blade | Tungsten | 0.5 | 900 | 40 | 25 | 24 |
| Example 4 | | | | | | | | |
| Comparative | Applicator roll | Roll coater | — | — | — | — | — | 24 |
| Example 5 | | | | | | | | |
| Comparative | Jet fountain | Blade | Tungsten | 0.4 | 1500 | 65 | 50 | 24 |
| Example 6 | | | | | | | | |
| Comparative | Applicator roll | Roll coater | Tungsten | — | — | — | — | 24 |
| Example 7 | | | | | | | | |

TABLE 5

| | Flattening treatment step | | | | Product | Raw material | | | |
|---|---|---|---|---|---|---|---|---|---|
| | | | Surface | Elastic roll | grams per | Waste | | | |
| | Stage | Temperature | roughness | hardness | square meter | paper | NBKP | LBKP | Contaminant |
| | number | ° C. | μm | Hv | g/m² | % | % | % | amount |
| Example 1 | 9 | 140 | 3 | 90 | 54.2 | 20 | 60 | 20 | 0.086 |
| Example 2 | 9 | 140 | 3 | 95 | 54.2 | 20 | 60 | 20 | 0.077 |
| Example 3 | 9 | 140 | 3 | 98 | 54.2 | 20 | 60 | 20 | 0.085 |
| Example 4 | 9 | 140 | 2.5 | 97 | 54.2 | 20 | 60 | 20 | 0.083 |
| Example 5 | 9 | 140 | 4.5 | 97 | 54.2 | 20 | 60 | 20 | 0.073 |
| Example 6 | 9 | 140 | 3 | 97 | 54.2 | 20 | 60 | 20 | 0.075 |
| Example 7 | 9 | 130 | 3 | 97 | 54.2 | 20 | 60 | 20 | 0.080 |
| Example 8 | 9 | 180 | 3 | 97 | 54.2 | 20 | 60 | 20 | 0.074 |
| Comparative | 9 | 140 | 2 | 88 | 54.2 | 20 | 60 | 20 | 0.084 |
| Example 1 | | | | | | | | | |
| Comparative | 9 | 140 | 2 | 95 | 54.2 | 20 | 60 | 20 | 0.070 |
| Example 2 | | | | | | | | | |
| Comparative | 9 | 140 | 2 | 95 | 54.2 | 20 | 60 | 20 | 0.086 |
| Example 3 | | | | | | | | | |
| Comparative | 9 | 120 | 3.5 | 88 | 54.2 | 20 | 60 | 20 | 0.073 |
| Example 4 | | | | | | | | | |
| Comparative | 9 | 180 | 5 | 88 | 54.2 | 20 | 60 | 20 | 0.087 |
| Example 5 | | | | | | | | | |
| Comparative | 1 nip | 120 | 2 | 95 | 54.2 | 20 | 60 | 20 | 0.070 |
| Example 6 | | | | | | | | | |
| Comparative | 1 nip | 160 | 3.5 | 95 | 54.2 | 20 | 60 | 20 | 0.080 |
| Example 7 | | | | | | | | | |

TABLE 6

| | Quality evaluation | | | | | | | | | | |
|---|---|---|---|---|---|---|---|---|---|---|---|
| | | Paper | | Specific | | Glossiness | Printing | | Yellow | Produc- | Overall |
| | Texture | breakage | Cockle | volume | Glossiness | unevenness | unevenness | Rigidity | change | tivity | evaluation |
| Example 1 | 5.7 | ◯ | ◯ | 1.17 | 60 | 4 | 4 | 65 | 5 | 4 | ◯ |
| Example 2 | 5.6 | ◯ | ◯ | 1.18 | 60 | 4 | 4 | 66 | 5 | 5 | ◯ |
| Example 3 | 5.6 | ◯ | ◯ | 1.17 | 62 | 5 | 4 | 65 | 5 | 4 | ⊚ |
| Example 4 | 5.6 | ◯ | ◯ | 1.17 | 61 | 4 | 4 | 67 | 5 | 4 | ◯ |
| Example 5 | 5.6 | ◯ | ◯ | 1.18 | 61 | 5 | 5 | 65 | 5 | 4 | ⊚ |
| Example 6 | 5.6 | ◯ | ◯ | 1.18 | 58 | 4 | 4 | 66 | 5 | 4 | ◯ |
| Example 7 | 5.6 | ◯ | ◯ | 1.18 | 60 | 4 | 4 | 67 | 5 | 4 | ◯ |
| Example 8 | 5.6 | ◯ | ◯ | 1.18 | 60 | 4 | 4 | 64 | 4 | 4 | ◯ |
| Comparative | 5.6 | Δ | Δ | 1.17 | 53 | 3 | 4 | 42 | 3 | 1 | Δ |
| Example 1 | | | | | | | | | | | |
| Comparative | 5.6 | X | X | 1.16 | 54 | 3 | 4 | 43 | 3 | 2 | X |
| Example 2 | | | | | | | | | | | |
| Comparative | 5.2 | ◯ | Δ | 1.18 | 52 | 1 | 1 | 48 | 3 | 2 | X |
| Example 3 | | | | | | | | | | | |
| Comparative | 5.4 | X | X | 1.18 | 53 | 2 | 3 | 44 | 4 | 3 | X |
| Example 4 | | | | | | | | | | | |
| Comparative | 5.2 | ◯ | Δ | 1.17 | 52 | 1 | 1 | 47 | 1 | 2 | X |
| Example 5 | | | | | | | | | | | |
| Comparative | 5.5 | X | X | 1.13 | 40 | 2 | 2 | 45 | 3 | 2 | X |
| Example 6 | | | | | | | | | | | |
| Comparative | 5.5 | Δ | Δ | 1.18 | 39 | 3 | 3 | 44 | 2 | 2 | X |
| Example 7 | | | | | | | | | | | |

TABLE 7

| | Wet paper forming step | | | | | | | | | Paper |
|---|---|---|---|---|---|---|---|---|---|---|
| | | Suction mode | | Press part (1 P) | | | | | Pre-calender | making |
| | Wire part | 1 | 2 | | Felt | Pre-dryer | Size press | After dryer | Soft calender | speed |
| | mode | Stage | Stage | Mode | constitution | Mode | Mode | Mode | Mode | m/min |
| Example 9 | Gap | Suction | Suction | Shoe press | Double felt | Single deck | Gate roll | Single deck | 1 Nip 1 stack | 1600 |
| | former | roll | blade | | | | | | | |
| Example | Gap | Suction | Suction | Shoe press | Double felt | Single deck | Gate roll | Single deck | 1 Nip 1 stack | 1600 |
| 10 | former | roll | blade | | | | | | | |
| Example | Gap | Suction | Suction | Shoe press | Double felt | Single deck | Gate roll | Single deck | 1 Nip 1 stack | 1600 |
| 11 | former | roll | blade | | | | | | | |
| Example | Gap | Suction | Suction | Shoe press | Double felt | Single deck | Gate roll | Single deck | 1 Nip 1 stack | 1600 |
| 12 | former | roll | blade | | | | | | | |
| Example | Gap | Suction | Suction | Shoe press | Double felt | Single deck | Gate roll | Single deck | 1 Nip 1 stack | 1600 |
| 13 | former | roll | blade | | | | | | | |
| Example | Gap | Suction | Suction | Shoe press | Double felt | Single deck | Gate roll | Single deck | 1 Nip 1 stack | 1600 |
| 14 | former | roll | blade | | | | | | | |
| Example | Gap | Suction | Suction | Shoe press | Double felt | Single deck | Gate roll | Single deck | 1 Nip 1 stack | 1600 |
| 15 | former | roll | blade | | | | | | | |
| Example | Gap | Suction | Suction | Shoe press | Double felt | Single deck | Gate roll | Single deck | 1 Nip 1 stack | 1600 |
| 16 | former | roll | blade | | | | | | | |
| Example | Gap | Suction | Suction | Shoe press | Double felt | Single deck | Gate roll | Single deck | 1 Nip 1 stack | 1600 |
| 17 | former | roll | blade | | | | | | | |
| Example | Gap | Suction | Suction | Shoe press | Double felt | Single deck | Gate roll | Single deck | 1 Nip 1 stack | 1600 |
| 18 | former | roll | blade | | | | | | | |
| Example | Gap | Suction | Suction | Shoe press | Double felt | Single deck | Gate roll | Single deck | 1 Nip 1 stack | 1600 |
| 19 | former | roll | blade | | | | | | | |
| Example | Gap | Suction | Suction | Shoe press | Double felt | Single deck | Gate roll | Single deck | 1 Nip 1 stack | 1600 |
| 20 | former | roll | blade | | | | | | | |
| Example | Gap | Suction | Suction | Shoe press | Double felt | Single deck | Gate roll | Single deck | 1 Nip 1 stack | 1600 |
| 21 | former | roll | blade | | | | | | | |
| Example | Gap | Suction | Suction | Shoe press | Double felt | Single deck | Gate roll | Single deck | 1 Nip 1 stack | 1600 |
| 22 | former | roll | blade | | | | | | | |
| Example | Gap | Suction | Suction | Shoe press | Double felt | Single deck | Gate roll | Single deck | 1 Nip 1 stack | 1600 |
| 23 | former | roll | blade | | | | | | | |

TABLE 8

| | First coating apparatus | | | | Coating |
|---|---|---|---|---|---|
| | | | Roll surface | | amount |
| | | Hardness | roughness | | Both faces |
| | Coater mode | Hv | μm | Material | g/m² |
| Example 9 | Roll | 80 | 5 | Polyethylene blended urethane roll | 4 |
| Example 10 | Roll | 80 | 5 | Polyethylene blended urethane roll | 6 |
| Example 11 | Roll | 80 | 5 | Polyethylene blended urethane roll | 8 |
| Example 12 | Roll | 80 | 5 | Polyethylene blended urethane roll | 10 |
| Example 13 | Roll | 80 | 5 | Polyethylene blended urethane roll | 6 |
| Example 14 | Roll | 80 | 5 | Polyethylene blended urethane roll | 6 |
| Example 15 | Roll | 80 | 5 | Polyethylene blended urethane roll | 6 |
| Example 16 | Roll | 80 | 5 | Polyethylene blended urethane roll | 5 |
| Example 17 | Roll | 80 | 5 | Polyethylene blended urethane roll | 5 |
| Example 18 | Roll | 80 | 5 | Polyethylene blended urethane roll | 5 |
| Example 19 | Roll | 80 | 5 | Polyethylene blended urethane roll | 5 |
| Example 20 | Roll | 80 | 5 | Polyethylene blended urethane roll | 5 |
| Example 21 | Roll | 80 | 5 | Polyethylene blended urethane roll | 5 |
| Example 22 | Roll | 80 | 5 | Polyethylene blended urethane roll | 5 |
| Example 23 | Roll | 80 | 5 | Polyethylene blended urethane roll | 5 |

TABLE 9

| | Second coating apparatus | | | | | | |
|---|---|---|---|---|---|---|---|
| | | | | | | | Fountain |
| | | | | Thickness | Hardness | | angle |
| | Coating mode | Mode | Material | mm | Hv | Bevel angle | Degree |
| Example 9 | Jet fountain | Blade | Tungsten | 0.6 | 1400 | 40 | 50 |
| Example 10 | Jet fountain | Blade | Tungsten | 0.6 | 1400 | 40 | 50 |
| Example 11 | Jet fountain | Blade | Tungsten | 0.6 | 1400 | 40 | 50 |
| Example 12 | Jet fountain | Blade | Tungsten | 0.6 | 1400 | 40 | 50 |
| Example 13 | Jet fountain | Blade | Tungsten | 0.6 | 1400 | 40 | 50 |
| Example 14 | Jet fountain | Blade | Tungsten | 0.6 | 1400 | 40 | 50 |
| Example 15 | Jet fountain | Blade | Tungsten | 0.6 | 1400 | 40 | 50 |
| Example 16 | Jet fountain | Blade | Tungsten | 0.6 | 1400 | 40 | 50 |
| Example 17 | Jet fountain | Blade | Tungsten | 0.6 | 1400 | 40 | 50 |
| Example 18 | Jet fountain | Blade | Tungsten | 0.6 | 1400 | 40 | 50 |
| Example 19 | Jet fountain | Blade | Tungsten | 0.6 | 1400 | 40 | 50 |
| Example 20 | Jet fountain | Blade | Tungsten | 0.6 | 1400 | 40 | 50 |
| Example 21 | Jet fountain | Blade | Tungsten | 0.6 | 1400 | 40 | 50 |
| Example 22 | Jet fountain | Blade | Tungsten | 0.6 | 1400 | 40 | 50 |
| Example 23 | Jet fountain | Blade | Tungsten | 0.6 | 1400 | 40 | 50 |

TABLE 10

| | | | | | | | | Coating amount |
|---|---|---|---|---|---|---|---|---|
| | Second coating apparatus | | | | | | | Product coating |
| | | | | Thickness | Hardness | Bevel | Fountain angle | amount |
| | Coating mode | Mode | Material | mm | Hv | angle | Degree | g/m² |
| Example 9 | Jet fountain | Blade | Tungsten | 0.6 | 1400 | 40 | 50 | 12 |
| Example 10 | Jet fountain | Blade | Tungsten | 0.6 | 1400 | 40 | 50 | 18 |
| Example 11 | Jet fountain | Blade | Tungsten | 0.6 | 1400 | 40 | 50 | 20 |
| Example 12 | Jet fountain | Blade | Tungsten | 0.6 | 1400 | 40 | 50 | 22 |
| Example 13 | Jet fountain | Blade | Tungsten | 0.6 | 1400 | 40 | 50 | 20 |
| Example 14 | Jet fountain | Blade | Tungsten | 0.6 | 1400 | 40 | 50 | 22 |
| Example 15 | Jet fountain | Blade | Tungsten | 0.6 | 1400 | 40 | 50 | 24 |
| Example 16 | Jet fountain | Blade | Tungsten | 0.6 | 1400 | 40 | 50 | 14 |
| Example 17 | Jet fountain | Blade | Tungsten | 0.6 | 1400 | 40 | 50 | 14 |
| Example 18 | Jet fountain | Blade | Tungsten | 0.6 | 1400 | 40 | 50 | 14 |
| Example 19 | Jet fountain | Blade | Tungsten | 0.6 | 1400 | 40 | 50 | 14 |
| Example 20 | Jet fountain | Blade | Tungsten | 0.6 | 1400 | 40 | 50 | 14 |
| Example 21 | Jet fountain | Blade | Tungsten | 0.6 | 1400 | 40 | 50 | 14 |
| Example 22 | Jet fountain | Blade | Tungsten | 0.6 | 1400 | 40 | 50 | 14 |
| Example 23 | Jet fountain | Blade | Tungsten | 0.6 | 1400 | 40 | 50 | 14 |

TABLE 11

| | Flattening treatment step | | | | Product | Raw material | | | |
|---|---|---|---|---|---|---|---|---|---|
| | | | Surface | Elastic roll | grams per | Waste | | | |
| | Stage | Temperature | roughness | hardness | square meter | paper | NBKP | LBKP | Contaminant |
| | number | ° C. | μm | Hv | g/m² | % | % | % | amount |
| Example 9 | 9 | 140 | 3 | 98 | 54.2 | 20 | 60 | 20 | 0.070 |
| Example 10 | 9 | 140 | 3 | 98 | 54.2 | 20 | 60 | 20 | 0.078 |
| Example 11 | 9 | 140 | 3 | 98 | 54.2 | 20 | 60 | 20 | 0.075 |
| Example 12 | 9 | 140 | 3 | 98 | 54.2 | 20 | 60 | 20 | 0.078 |
| Example 13 | 9 | 140 | 3 | 98 | 54.2 | 20 | 60 | 20 | 0.085 |
| Example 14 | 9 | 140 | 3 | 98 | 54.2 | 20 | 60 | 20 | 0.088 |
| Example 15 | 9 | 140 | 3 | 98 | 54.2 | 20 | 60 | 20 | 0.084 |
| Example 16 | 9 | 140 | 3 | 98 | 54.2 | 10 | 60 | 30 | 0.068 |
| Example 17 | 9 | 140 | 3 | 98 | 54.2 | 20 | 50 | 30 | 0.082 |
| Example 18 | 9 | 140 | 3 | 98 | 54.2 | 30 | 40 | 30 | 0.083 |
| Example 19 | 9 | 140 | 3 | 98 | 54.2 | 40 | 30 | 30 | 0.088 |
| Example 20 | 9 | 140 | 3 | 98 | 54.2 | 50 | 30 | 20 | 0.092 |
| Example 21 | 9 | 140 | 3 | 98 | 54.2 | 60 | 30 | 10 | 0.093 |
| Example 22 | 9 | 140 | 3 | 98 | 54.2 | 70 | 30 | — | 0.095 |
| Example 23 | 9 | 140 | 3 | 98 | 54.2 | 100 | — | — | 0.098 |

TABLE 12

| | Quality evaluation | | | | | | | | | | |
|---|---|---|---|---|---|---|---|---|---|---|---|
| | | Paper | | Specific | | Glossiness | Printing | | Yellow | | Overall |
| | Texture | breakage | Cockle | volume | Glossiness | unevenness | unevenness | Rigidity | change | Productivity | evaluation |
| Example 9 | 5.6 | ◯ | ◯ | 1.26 | 60 | 4 | 3 | 65 | 5 | 4 | ⊚ |
| Example | 5.6 | ◯ | ◯ | 1.25 | 62 | 4 | 4 | 66 | 5 | 4 | ⊚ |
| 10 | | | | | | | | | | | |
| Example | 5.5 | ◯ | ◯ | 1.23 | 62 | 5 | 5 | 65 | 5 | 4 | ⊚ |
| 11 | | | | | | | | | | | |
| Example | 5.6 | ◯ | ◯ | 1.20 | 62 | 5 | 5 | 66 | 5 | 4 | ⊚ |
| 12 | | | | | | | | | | | |
| Example | 5.6 | ◯ | ◯ | 1.19 | 60 | 4 | 4 | 65 | 5 | 4 | ⊚ |
| 13 | | | | | | | | | | | |
| Example | 5.5 | ◯ | ◯ | 1.16 | 62 | 4 | 4 | 65 | 5 | 4 | ⊚ |
| 14 | | | | | | | | | | | |
| Example | 5.6 | ◯ | ◯ | 1.15 | 63 | 4 | 5 | 65 | 5 | 4 | ⊚ |
| 15 | | | | | | | | | | | |
| Example | 5.6 | ◯ | ◯ | 1.13 | 62 | 5 | 5 | 66 | 5 | 4 | ⊚ |
| 16 | | | | | | | | | | | |
| Example | 5.6 | ◯ | ◯ | 1.09 | 62 | 5 | 5 | 65 | 5 | 4 | ⊚ |
| 17 | | | | | | | | | | | |
| Example | 5.6 | ◯ | ◯ | 1.07 | 62 | 5 | 5 | 65 | 5 | 4 | ⊚ |
| 18 | | | | | | | | | | | |
| Example | 5.6 | ◯ | ◯ | 1.04 | 61 | 5 | 4 | 64 | 5 | 4 | ⊚ |
| 19 | | | | | | | | | | | |
| Example | 5.5 | ◯ | ◯ | 1.02 | 61 | 4 | 4 | 63 | 5 | 4 | ⊚ |
| 20 | | | | | | | | | | | |
| Example | 5.5 | ◯ | ◯ | 1.02 | 61 | 4 | 4 | 63 | 4 | 4 | ◯ |
| 21 | | | | | | | | | | | |
| Example | 5.4 | ◯ | ◯ | 1.02 | 61 | 4 | 4 | 62 | 4 | 4 | ◯ |
| 22 | | | | | | | | | | | |
| Example | 5.4 | ◯ | ◯ | 1.01 | 60 | 4 | 3 | 62 | 4 | 4 | ◯ |
| 23 | | | | | | | | | | | |

TABLE 13

| | Wet paper forming step | | | | | | | | | |
|---|---|---|---|---|---|---|---|---|---|---|
| | | Suction mode | | Press part (1 P) | | | Size | | Pre-calender | Paper |
| | Wire part | 1 | 2 | | Felt | Pre-dryer | press | After dryer | Soft calender | making speed |
| | mode | Stage | Stage | Mode | constitution | Mode | Mode | Mode | Mode | m/min |
| Example | Gap | Suction | Suction | Shoe press | Double felt | Single | Gate roll | Single deck | 1 Nip 1 stack | 1600 |
| 24 | former | roll | blade | | | deck | | | | |
| Example | Gap | Suction | Suction | Shoe press | Double felt | Single | Gate roll | Single deck | 1 Nip 1 stack | 1600 |
| 25 | former | roll | blade | | | deck | | | | |
| Example | Gap | Suction | Suction | Shoe press | Double felt | Single | Gate roll | Single deck | 1 Nip 1 stack | 1600 |
| 26 | former | roll | blade | | | deck | | | | |
| Example | Gap | Suction | Suction | Shoe press | Double felt | Single | Gate roll | Single deck | 1 Nip 1 stack | 1600 |
| 27 | former | roll | blade | | | deck | | | | |
| Example | Gap | Suction | Suction | Shoe press | Double felt | Single | Gate roll | Single deck | 1 Nip 1 stack | 1600 |
| 28 | former | roll | blade | | | deck | | | | |
| Example | Gap | Suction | Suction | Shoe press | Double felt | Single | Gate roll | Single deck | 1 Nip 1 stack | 1600 |
| 29 | former | roll | blade | | | deck | | | | |
| Example | Gap | Suction | Suction | Shoe press | Double felt | Single | Gate roll | Single deck | 1 Nip 1 stack | 1600 |
| 30 | former | roll | blade | | | deck | | | | |
| Example | Gap | Suction | Suction | Shoe press | Double felt | Single | Gate roll | Single deck | 1 Nip 1 stack | 1600 |
| 31 | former | roll | blade | | | deck | | | | |
| Example | Gap | Suction | Suction | Shoe press | Double felt | Single | Gate roll | Single deck | 1 Nip 1 stack | 1600 |
| 32 | former | roll | blade | | | deck | | | | |
| Example | Gap | Suction | Suction | Shoe press | Double felt | Single | Gate roll | Single deck | 1 Nip 1 stack | 1600 |
| 33 | former | roll | blade | | | deck | | | | |

TABLE 14

| | First coating apparatus | | | | |
|---|---|---|---|---|---|
| | | | Roll surface | | Coating amount |
| | | Hardness | roughness | | Both faces |
| | Coater mode | Hv | μm | Material | g/m² |
| Example 24 | Roll | 80 | 5 | Polyethylene blended urethane roll | 4 |
| Example 25 | Roll | 80 | 5 | Polyethylene blended urethane roll | 4 |
| Example 26 | Roll | 80 | 5 | Polyethylene blended urethane roll | 4 |
| Example 27 | Roll | 80 | 5 | Polyethylene blended urethane roll | 4 |
| Example 28 | Roll | 80 | 5 | Polyethylene blended urethane roll | 4 |
| Example 29 | Roll | 80 | 5 | Polyethylene blended urethane roll | 4 |
| Example 30 | Roll | 80 | 5 | Polyethylene blended urethane roll | 4 |
| Example 31 | Roll | 80 | 5 | Polyethylene blended urethane roll | 10 |
| Example 32 | Roll | 80 | 5 | Polyethylene blended urethane roll | 10 |
| Example 33 | Roll | 80 | 5 | Polyethylene blended urethane roll | 10 |

TABLE 15

| | Second coating apparatus (Front) | | | | | | |
|---|---|---|---|---|---|---|---|
| | | | | Thickness | Hardness | | Fountain angle |
| | Coating mode | Mode | Material | mm | Hv | Bevel angle | Degree |
| Example 24 | Jet fountain | Blade | Tungsten | 0.6 | 1400 | 40 | 50 |
| Example 25 | Jet fountain | Blade | Tungsten | 0.6 | 1400 | 40 | 50 |
| Example 26 | Jet fountain | Blade | Tungsten | 0.6 | 1400 | 40 | 50 |
| Example 27 | Jet fountain | Blade | Tungsten | 0.6 | 1400 | 40 | 50 |
| Example 28 | Jet fountain | Blade | Tungsten | 0.6 | 1400 | 40 | 50 |
| Example 29 | Jet fountain | Blade | Tungsten | 0.6 | 1400 | 40 | 50 |
| Example 30 | Jet fountain | Blade | Tungsten | 0.6 | 1400 | 40 | 50 |
| Example 31 | Jet fountain | Blade | Tungsten | 0.6 | 1400 | 40 | 50 |
| Example 32 | Jet fountain | Blade | Tungsten | 0.6 | 1400 | 40 | 50 |
| Example 33 | Jet fountain | Blade | Tungsten | 0.6 | 1400 | 40 | 50 |

TABLE 16

| | | | | | | | | Coating |
|---|---|---|---|---|---|---|---|---|
| | | | | | | | | amount |
| | | | | | | | | Product |
| | Second coating apparatus (Back) | | | | | | | coating |
| | Coating | | | Thickness | Hardness | | Fountain angle | amount |
| | mode | Mode | Material | mm | Hv | Bevel angle | Degree | g/m² |
| Example | Jet | Blade | Tungsten | 0.6 | 1400 | 40 | 50 | 12 |
| 24 | fountain | | | | | | | |
| Example | Jet | Blade | Tungsten | 0.6 | 1400 | 40 | 50 | 12 |
| 25 | fountain | | | | | | | |
| Example | Jet | Blade | Tungsten | 0.6 | 1400 | 40 | 50 | 12 |
| 26 | fountain | | | | | | | |
| Example | Jet | Blade | Tungsten | 0.6 | 1400 | 40 | 50 | 12 |
| 27 | fountain | | | | | | | |
| Example | Jet | Blade | Tungsten | 0.6 | 1400 | 40 | 50 | 12 |
| 28 | fountain | | | | | | | |
| Example | Jet | Blade | Tungsten | 0.6 | 1400 | 40 | 50 | 12 |
| 29 | fountain | | | | | | | |
| Example | Jet | Blade | Tungsten | 0.6 | 1400 | 40 | 50 | 12 |
| 30 | fountain | | | | | | | |
| Example | Jet | Blade | Tungsten | 0.6 | 1400 | 40 | 50 | 24 |
| 31 | fountain | | | | | | | |
| Example | Jet | Blade | Tungsten | 0.6 | 1400 | 40 | 50 | 24 |
| 32 | fountain | | | | | | | |
| Example | Jet | Blade | Tungsten | 0.6 | 1400 | 40 | 50 | 24 |
| 33 | fountain | | | | | | | |

TABLE 17

| | Flattening treatment step | | | | Product | Raw material | | | |
|---|---|---|---|---|---|---|---|---|---|
| | | | Surface | Elastic roll | grams per | Waste | | | |
| | | Temperature | roughness | hardness | square meter | paper | NBKP | LBKP | Contaminant |
| | Stage number | ° C. | μm | Hv | g/m² | % | % | % | amount |
| Example | 9 | 140 | 3 | 98 | 44 | 20 | 60 | 20 | 0.089 |
| 24 | | | | | | | | | |
| Example | 9 | 140 | 3 | 98 | 45 | 20 | 60 | 20 | 0.076 |
| 25 | | | | | | | | | |
| Example | 9 | 140 | 3 | 98 | 46 | 20 | 60 | 20 | 0.082 |
| 26 | | | | | | | | | |
| Example | 9 | 140 | 3 | 98 | 47 | 20 | 60 | 20 | 0.074 |
| 27 | | | | | | | | | |
| Example | 9 | 140 | 3 | 98 | 48 | 20 | 60 | 20 | 0.075 |
| 28 | | | | | | | | | |
| Example | 9 | 140 | 3 | 98 | 50 | 20 | 60 | 20 | 0.084 |
| 29 | | | | | | | | | |
| Example | 9 | 140 | 3 | 98 | 54 | 20 | 60 | 20 | 0.086 |
| 30 | | | | | | | | | |
| Example | 9 | 140 | 3 | 98 | 58 | 20 | 60 | 20 | 0.078 |
| 31 | | | | | | | | | |
| Example | 9 | 140 | 3 | 98 | 60 | 20 | 60 | 20 | 0.070 |
| 32 | | | | | | | | | |
| Example | 9 | 140 | 3 | 98 | 64 | 20 | 60 | 20 | 0.079 |
| 33 | | | | | | | | | |

TABLE 18

| | Quality evaluation | | | | | | | | | | |
|---|---|---|---|---|---|---|---|---|---|---|---|
| | | Paper | | Specific | | Glossiness | Printing | | Yellow | | Overall |
| | Texture | breakage | Cockle | volume | Glossiness | unevenness | unevenness | Rigidity | change | Productivity | evaluation |
| Example | 5.6 | ◯ | ◯ | 1.01 | 60 | 4 | 4 | 55 | 5 | 4 | ◯ |
| 24 | | | | | | | | | | | |
| Example | 5.5 | ◯ | ◯ | 1.02 | 60 | 4 | 4 | 59 | 5 | 4 | ◯ |
| 25 | | | | | | | | | | | |
| Example | 5.6 | ◯ | ◯ | 1.05 | 61 | 4 | 4 | 62 | 5 | 4 | ⊚ |
| 26 | | | | | | | | | | | |
| Example | 5.5 | ◯ | ◯ | 1.09 | 61 | 5 | 4 | 59 | 5 | 4 | ⊚ |
| 27 | | | | | | | | | | | |
| Example | 5.5 | ◯ | ◯ | 1.12 | 62 | 5 | 4 | 61 | 5 | 4 | ⊚ |
| 28 | | | | | | | | | | | |
| Example | 5.6 | ◯ | ◯ | 1.13 | 62 | 5 | 4 | 59 | 5 | 5 | ⊚ |
| 29 | | | | | | | | | | | |
| Example | 5.5 | ◯ | ◯ | 1.13 | 62 | 5 | 5 | 62 | 5 | 5 | ⊚ |
| 30 | | | | | | | | | | | |
| Example | 5.4 | ◯ | ◯ | 1.26 | 62 | 5 | 5 | 65 | 5 | 5 | ⊚ |
| 31 | | | | | | | | | | | |
| Example | 5.5 | ◯ | ◯ | 1.27 | 63 | 5 | 5 | 68 | 5 | 5 | ⊚ |
| 32 | | | | | | | | | | | |
| Example | 5.3 | ◯ | ◯ | 1.28 | 63 | 5 | 5 | 71 | 5 | 5 | ⊚ |
| 33 | | | | | | | | | | | |

TABLE 19

| | Wet paper forming step | | | | | | | | | paper |
|---|---|---|---|---|---|---|---|---|---|---|
| | | Suction mode | | Press part (1 P) | | | | After | Pre-calender | making |
| | Wire part | 1 | 2 | | Felt | Pre-dryer | Size press | dryer | Soft calender | speed |
| | mode | Stage | Stage | Mode | constitution | Mode | Mode | Mode | Mode | m/min |
| Example | Gap | Suction | Suction | Shoe | Double felt | Single deck | Gate roll | Single | 1 Nip 1 stack | 1000 |
| 34 | former | roll | blade | press | | | | deck | | |
| Example | Gap | Suction | Suction | Shoe | Double felt | Single deck | Gate roll | Single | 1 Nip 1 stack | 1100 |
| 35 | former | roll | blade | press | | | | deck | | |
| Example | Gap | Suction | Suction | Shoe | Double felt | Single deck | Gate roll | Single | 1 Nip 1 stack | 1200 |
| 36 | former | roll | blade | press | | | | deck | | |
| Example | Gap | Suction | Suction | Shoe | Double felt | Single deck | Gate roll | Single | 1 Nip 1 stack | 1300 |
| 37 | former | roll | blade | press | | | | deck | | |
| Example | Gap | Suction | Suction | Shoe | Double felt | Single deck | Gate roll | Single | 1 Nip 1 stack | 1400 |
| 38 | former | roll | blade | press | | | | deck | | |
| Example | Gap | Suction | Suction | Shoe | Double felt | Single deck | Gate roll | Single | 1 Nip 1 stack | 1500 |
| 39 | former | roll | blade | press | | | | deck | | |
| Example | Gap | Suction | Suction | Shoe | Double felt | Single deck | Gate roll | Single | 1 Nip 1 stack | 1600 |
| 40 | former | roll | blade | press | | | | deck | | |
| Example | Gap | Suction | Suction | Shoe | Double felt | Single deck | Gate roll | Single | 1 Nip 1 stack | 1700 |
| 41 | former | roll | blade | press | | | | deck | | |
| Example | Gap | Suction | Suction | Shoe | Double felt | Single deck | Gate roll | Single | 1 Nip 1 stack | 1800 |
| 42 | former | roll | blade | press | | | | deck | | |

TABLE 20

| | First coating apparatus | | | | |
|---|---|---|---|---|---|
| | | | Roll surface | | Coating amount |
| | Coater | Hardness | roughness | | Both faces |
| | mode | Hv | μm | Material | g/m² |
| Example | Roll | 80 | 5 | Polyethylene blended urethane roll | 4 |
| 34 | | | | | |
| Example | Roll | 80 | 5 | Polyethylene blended urethane roll | 4 |
| 35 | | | | | |
| Example | Roll | 80 | 5 | Polyethylene blended urethane roll | 4 |
| 36 | | | | | |
| Example | Roll | 80 | 5 | Polyethylene blended urethane roll | 4 |
| 37 | | | | | |
| Example | Roll | 80 | 5 | Polyethylene blended urethane roll | 4 |
| 38 | | | | | |
| Example | Roll | 80 | 5 | Polyethylene blended urethane roll | 4 |
| 39 | | | | | |
| Example | Roll | 80 | 5 | Polyethylene blended urethane roll | 4 |
| 40 | | | | | |
| Example | Roll | 80 | 5 | Polyethylene blended urethane roll | 4 |
| 41 | | | | | |
| Example | Roll | 80 | 5 | Polyethylene blended urethane roll | 4 |
| 42 | | | | | |

TABLE 21

| | Second coating apparatus (Front) | | | | | | |
|---|---|---|---|---|---|---|---|
| | | | | Thickness | Hardness | Bevel | Fountain angle |
| | Coating mode | Mode | Material | mm | Hv | angle | Degree |
| Example | Jet fountain | Blade | Tungsten | 0.6 | 1400 | 40 | 50 |
| 34 | | | | | | | |
| Example | Jet fountain | Blade | Tungsten | 0.6 | 1400 | 40 | 50 |
| 35 | | | | | | | |
| Example | Jet fountain | Blade | Tungsten | 0.6 | 1400 | 40 | 50 |
| 36 | | | | | | | |
| Example | Jet fountain | Blade | Tungsten | 0.6 | 1400 | 40 | 50 |
| 37 | | | | | | | |
| Example | Jet fountain | Blade | Tungsten | 0.6 | 1400 | 40 | 50 |
| 38 | | | | | | | |
| Example | Jet fountain | Blade | Tungsten | 0.6 | 1400 | 40 | 50 |
| 39 | | | | | | | |
| Example | Jet fountain | Blade | Tungsten | 0.6 | 1400 | 40 | 50 |
| 40 | | | | | | | |
| Example | Jet fountain | Blade | Tungsten | 0.6 | 1400 | 40 | 50 |
| 41 | | | | | | | |
| Example | Jet fountain | Blade | Tungsten | 0.6 | 1400 | 40 | 50 |
| 42 | | | | | | | |

TABLE 22

| | | | | | | | | Coating |
|---|---|---|---|---|---|---|---|---|
| | | | | | | | | amount |
| | Second coating apparatus (Back) | | | | | | | Product |
| | | | | | | | Fountain | coating |
| | | | | Thickness | Hardness | | angle | amount |
| | Coating mode | Mode | Material | mm | Hv | Bevel angle | Degree | g/m² |
| Example | Jet fountain | Blade | Tungsten | 0.6 | 1400 | 40 | 50 | 12 |
| 34 | | | | | | | | |
| Example | Jet fountain | Blade | Tungsten | 0.6 | 1400 | 40 | 50 | 12 |
| 35 | | | | | | | | |
| Example | Jet fountain | Blade | Tungsten | 0.6 | 1400 | 40 | 50 | 12 |
| 36 | | | | | | | | |
| Example | Jet fountain | Blade | Tungsten | 0.6 | 1400 | 40 | 50 | 12 |
| 37 | | | | | | | | |
| Example | Jet fountain | Blade | Tungsten | 0.6 | 1400 | 40 | 50 | 12 |
| 38 | | | | | | | | |
| Example | Jet fountain | Blade | Tungsten | 0.6 | 1400 | 40 | 50 | 12 |
| 39 | | | | | | | | |
| Example | Jet fountain | Blade | Tungsten | 0.6 | 1400 | 40 | 50 | 12 |
| 40 | | | | | | | | |
| Example | Jet fountain | Blade | Tungsten | 0.6 | 1400 | 40 | 50 | 12 |
| 41 | | | | | | | | |
| Example | Jet fountain | Blade | Tungsten | 0.6 | 1400 | 40 | 50 | 12 |
| 42 | | | | | | | | |

TABLE 23

| | Flattening treatment step | | | | Product | Raw material | | | |
|---|---|---|---|---|---|---|---|---|---|
| | | | Surface | Elastic roll | grams per | Waste | | | |
| | | Temperature | roughness | hardness | square meter | paper | NBKP | LBKP | Contaminant |
| | Stage number | ° C. | μm | Hv | g/m² | % | % | % | amount |
| Example | 9 | 140 | 3 | 98 | 54 | 20 | 60 | 20 | 0.071 |
| 34 | | | | | | | | | |
| Example | 9 | 140 | 3 | 98 | 54 | 20 | 60 | 20 | 0.087 |
| 35 | | | | | | | | | |
| Example | 9 | 140 | 3 | 98 | 54 | 20 | 60 | 20 | 0.072 |
| 36 | | | | | | | | | |
| Example | 9 | 140 | 3 | 98 | 54 | 20 | 60 | 20 | 0.078 |
| 37 | | | | | | | | | |
| Example | 9 | 140 | 3 | 98 | 54 | 20 | 60 | 20 | 0.087 |
| 38 | | | | | | | | | |
| Example | 9 | 140 | 3 | 98 | 54 | 20 | 60 | 20 | 0.071 |
| 39 | | | | | | | | | |
| Example | 9 | 140 | 3 | 98 | 54 | 20 | 60 | 20 | 0.075 |
| 40 | | | | | | | | | |
| Example | 9 | 140 | 3 | 98 | 54 | 20 | 60 | 20 | 0.088 |
| 41 | | | | | | | | | |
| Example | 9 | 140 | 3 | 98 | 54 | 20 | 60 | 20 | 0.077 |
| 42 | | | | | | | | | |

TABLE 24

| | Quality evaluation | | | | | | | | | | |
|---|---|---|---|---|---|---|---|---|---|---|---|
| | | Paper | | Specific | | Glossiness | Printing | | Yellow | | Overall |
| | Texture | breakage | Cockle | volume | Glossiness | unevenness | unevenness | Rigidity | change | Productivity | evaluation |
| Example | 5.5 | ◯ | ◯ | 1.11 | 64 | 5 | 5 | 55 | 5 | 3 | ◯ |
| 34 | | | | | | | | | | | |
| Example | 5.4 | ◯ | ◯ | 1.14 | 63 | 5 | 5 | 56 | 5 | 3 | ◯ |
| 35 | | | | | | | | | | | |
| Example | 5.4 | ◯ | ◯ | 1.15 | 63 | 5 | 5 | 60 | 5 | 4 | ⊚ |
| 36 | | | | | | | | | | | |
| Example | 5.5 | ◯ | ◯ | 1.16 | 62 | 5 | 5 | 63 | 5 | 4 | ⊚ |
| 37 | | | | | | | | | | | |
| Example | 5.5 | ◯ | ◯ | 1.17 | 62 | 5 | 5 | 63 | 5 | 5 | ⊚ |
| 38 | | | | | | | | | | | |
| Example | 5.5 | ◯ | ◯ | 1.19 | 62 | 5 | 5 | 64 | 5 | 5 | ⊚ |
| 39 | | | | | | | | | | | |
| Example | 5.4 | ◯ | ◯ | 1.22 | 61 | 5 | 5 | 65 | 5 | 5 | ⊚ |
| 40 | | | | | | | | | | | |
| Example | 5.4 | ◯ | ◯ | 1.25 | 61 | 5 | 5 | 66 | 5 | 5 | ⊚ |
| 41 | | | | | | | | | | | |
| Example | 5.5 | ◯ | ◯ | 1.28 | 60 | 4 | 4 | 68 | 5 | 5 | ◯ |
| 42 | | | | | | | | | | | |

TABLE 25

| | Wet paper | | | | | | | | | Paper |
|---|---|---|---|---|---|---|---|---|---|---|
| | forming step | | | Press part (1 P) | | | | | Pre-calender | making |
| | Wire part | Suction mode | | | Felt | Pre-dryer | Size press | After dryer | Soft calender | speed |
| | mode | 1 Stage | 2 Stage | Mode | constitution | Mode | Mode | Mode | Mode | m/min |
| Example | Gap | Suction | Suction | Shoe press | Double felt | Single deck | Gate roll | Single deck | 1 Nip 1 stack | 1600 |
| 43 | former | roll | blade | | | | | | | |
| Example | Gap | Suction | Suction | Shoe press | Double felt | Single deck | Gate roll | Single deck | 1 Nip 1 stack | 1600 |
| 44 | former | roll | blade | | | | | | | |
| Example | Gap | Suction | Suction | Shoe press | Double felt | Single deck | Gate roll | Single deck | 1 Nip 1 stack | 1600 |
| 45 | former | roll | blade | | | | | | | |
| Example | Gap | Suction | Suction | Shoe press | Double felt | Single deck | Gate roll | Single deck | 1 Nip 1 stack | 1600 |
| 46 | former | roll | blade | | | | | | | |
| Example | Gap | Suction | Suction | Shoe press | Double felt | Single deck | Gate roll | Single deck | 1 Nip 1 stack | 1600 |
| 47 | former | roll | blade | | | | | | | |
| Example | Gap | Suction | Suction | Shoe press | Double felt | Single deck | Gate roll | Single deck | 1 Nip 1 stack | 1600 |
| 48 | former | roll | blade | | | | | | | |
| Example | Gap | Suction | Suction | Shoe press | Double felt | Single deck | Gate roll | Single deck | 1 Nip 1 stack | 1600 |
| 49 | former | roll | blade | | | | | | | |
| Example | Gap | Suction | Suction | Shoe press | Double felt | Single deck | Gate roll | Single deck | 1 Nip 1 stack | 1800 |
| 50 | former | roll | blade | | | | | | | |
| Example | Gap | Suction | Suction | Shoe press | Double felt | Single deck | Gate roll | Single deck | 1 Nip 1 stack | 1300 |
| 51 | former | roll | blade | | | | | | | |
| Example | Gap | Suction | Suction | Shoe press | Double felt | Single deck | Gate roll | Single deck | 1 Nip 1 stack | 1600 |
| 52 | former | roll | blade | | | | | | | |
| Example | Gap | Suction | Suction | Shoe press | Double felt | Single deck | Gate roll | Single deck | 1 Nip 1 stack | 1600 |
| 53 | former | roll | blade | | | | | | | |
| Example | Gap | Suction | Suction | Shoe press | Double felt | Single deck | Gate roll | Single deck | 1 Nip 1 stack | 1600 |
| 54 | former | roll | blade | | | | | | | |
| Example | Gap | Suction | Suction | Shoe press | Double felt | Single deck | Gate roll | Single deck | 1 Nip 1 stack | 1600 |
| 55 | former | roll | blade | | | | | | | |
| Example | Gap | Suction | Suction | Shoe press | Double felt | Single deck | Gate roll | Single deck | 1 Nip 1 stack | 1600 |
| 56 | former | roll | blade | | | | | | | |
| Example | Gap | Suction | Suction | Shoe press | Double felt | Single deck | Gate roll | Single deck | 1 Nip 1 stack | 1600 |
| 57 | former | roll | blade | | | | | | | |
| Example | Gap | Suction | Suction | Shoe press | Double felt | Single deck | Gate roll | Single deck | 1 Nip 1 stack | 1600 |
| 58 | former | roll | blade | | | | | | | |
| Example | Gap | Suction | Suction | Shoe press | Double felt | Single deck | Gate roll | Single deck | 1 Nip 1 stack | 1600 |
| 59 | former | roll | blade | | | | | | | |
| Example | Gap | Suction | Suction | Shoe press | Double felt | Single deck | Gate roll | Single deck | 1 Nip 1 stack | 1600 |
| 60 | former | roll | blade | | | | | | | |
| Example | Gap | Suction | Suction | Shoe press | Double felt | Single deck | Gate roll | Single deck | 1 Nip 1 stack | 1600 |
| 61 | former | roll | blade | | | | | | | |
| Example | Gap | Suction | Suction | Shoe press | Double felt | Single deck | Gate roll | Single deck | 1 Nip 1 stack | 1600 |
| 62 | former | roll | blade | | | | | | | |
| Example | Gap | Suction | Suction | Shoe press | Double felt | Single deck | Gate roll | Single deck | 1 Nip 1 stack | 1800 |
| 63 | former | roll | blade | | | | | | | |
| Example | Gap | Suction | Suction | Shoe press | Double felt | Single deck | Gate roll | Single deck | 1 Nip 1 stack | 1300 |
| 64 | former | roll | blade | | | | | | | |
| Example | Gap | Suction | Suction | Shoe press | Double felt | Single deck | Gate roll | Single deck | 1 Nip 1 stack | 1600 |
| 65 | former | roll | blade | | | | | | | |
| Example | Gap | Suction | Suction | Shoe press | Double felt | Single deck | Gate roll | Single deck | 1 Nip 1 stack | 1600 |
| 66 | former | roll | blade | | | | | | | |
| Example | Gap | Suction | Suction | Shoe press | Double felt | Single deck | Gate roll | Single deck | 1 Nip 1 stack | 1600 |
| 67 | former | roll | blade | | | | | | | |
| Example | Gap | Suction | Suction | Shoe press | Double felt | Single deck | Gate roll | Single deck | 1 Nip 1 stack | 1600 |
| 68 | former | roll | blade | | | | | | | |
| Example | Gap | Suction | Suction | Shoe press | Double felt | Single deck | Gate roll | Single deck | 1 Nip 1 stack | 1600 |
| 69 | former | roll | blade | | | | | | | |

TABLE 26

| | First coating apparatus | | | | |
|---|---|---|---|---|---|
| | | | Roll surface | | Coating amount |
| | Coater | Hardness | roughness | | Both faces |
| | mode | Hv | μm | Material | g/m² |
| Example 43 | Roll | 80 | 5 | Polyethylene blended urethane roll | 4 |
| Example 44 | Roll | 80 | 5 | Polyethylene blended urethane roll | 8 |
| Example 45 | Roll | 80 | 5 | Polyethylene blended urethane roll | 10 |
| Example 46 | Roll | 80 | 5 | Polyethylene blended urethane roll | 12 |
| Example 47 | Roll | 80 | 5 | Polyethylene blended urethane roll | 14 |
| Example 48 | Roll | 80 | 5 | Polyethylene blended urethane roll | 18 |
| Example 49 | Roll | 80 | 5 | Polyethylene blended urethane roll | 20 |
| Example 50 | Roll | 80 | 5 | Polyethylene blended urethane roll | 10 |
| Example 51 | Roll | 80 | 5 | Polyethylene blended urethane roll | 10 |
| Example 52 | Roll | 80 | 5 | Polyethylene blended urethane roll | 10 |
| Example 53 | Roll | 80 | 5 | Polyethylene blended urethane roll | 10 |
| Example 54 | Roll | 80 | 5 | Polyethylene blended urethane roll | 10 |
| Example 55 | Roll | 80 | 5 | Polyethylene blended urethane roll | 10 |
| Example 56 | Roll | 80 | 5 | Polyethylene blended urethane roll | 10 |
| Example 57 | — | — | — | — | — |
| Example 58 | — | — | — | — | — |
| Example 59 | — | — | — | — | — |
| Example 60 | — | — | — | — | — |
| Example 61 | — | — | — | — | — |
| Example 62 | — | — | — | — | — |
| Example 63 | — | — | — | — | — |
| Example 64 | — | — | — | — | — |
| Example 65 | — | — | — | — | — |
| Example 66 | — | — | — | — | — |
| Example 67 | — | — | — | — | — |
| Example 68 | — | — | — | — | — |
| Example 69 | — | — | — | — | — |

TABLE 27

| | Second coating apparatus | | | | | | |
|---|---|---|---|---|---|---|---|
| | | | | Thickness | Hardness | | Fountain angle |
| | Coating mode | Mode | Material | mm | Hv | Bevel angle | Degree |
| Example 43 | — | — | — | — | — | — | — |
| Example 44 | — | — | — | — | — | — | — |
| Example 45 | — | — | — | — | — | — | — |
| Example 46 | — | — | — | — | — | — | — |
| Example 47 | — | — | — | — | — | — | — |
| Example 48 | — | — | — | — | — | — | — |
| Example 49 | — | — | — | — | — | — | — |
| Example 50 | — | — | — | — | — | — | — |
| Example 51 | — | — | — | — | — | — | — |
| Example 52 | — | — | — | — | — | — | — |
| Example 53 | — | — | — | — | — | — | — |
| Example 54 | — | — | — | — | — | — | — |
| Example 55 | — | — | — | — | — | — | — |
| Example 56 | — | — | — | — | — | — | — |
| Example 57 | Jet fountain | Blade | Tungsten | 0.6 | 1400 | 40 | 50 |
| Example 58 | Jet fountain | Blade | Tungsten | 0.6 | 1400 | 40 | 50 |
| Example 59 | Jet fountain | Blade | Tungsten | 0.6 | 1400 | 40 | 50 |
| Example 60 | Jet fountain | Blade | Tungsten | 0.6 | 1400 | 40 | 50 |
| Example 61 | Jet fountain | Blade | Tungsten | 0.6 | 1400 | 40 | 50 |
| Example 62 | Jet fountain | Blade | Tungsten | 0.6 | 1400 | 40 | 50 |
| Example 63 | Jet fountain | Blade | Tungsten | 0.6 | 1400 | 40 | 50 |
| Example 64 | Jet fountain | Blade | Tungsten | 0.6 | 1400 | 40 | 50 |
| Example 65 | Jet fountain | Blade | Tungsten | 0.6 | 1400 | 40 | 50 |
| Example 66 | Jet fountain | Blade | Tungsten | 0.6 | 1400 | 40 | 50 |
| Example 67 | Jet fountain | Blade | Tungsten | 0.6 | 1400 | 40 | 50 |
| Example 68 | Jet fountain | Blade | Tungsten | 0.6 | 1400 | 40 | 50 |
| Example 69 | Jet fountain | Blade | Tungsten | 0.6 | 1400 | 40 | 50 |

TABLE 28

| | Second coating apparatus (Back) | | | | | | | Coating amount |
|---|---|---|---|---|---|---|---|---|
| | | | | | | | Fountain | Product coating |
| | | | | Thickness | Hardness | Bevel | angle | amount |
| | Coating mode | Mode | Material | mm | Hv | angle | Degree | g/m² |
| Example 43 | — | — | — | — | — | — | — | 4 |
| Example 44 | — | — | — | — | — | — | — | 8 |
| Example 45 | — | — | — | — | — | — | — | 10 |
| Example 46 | — | — | — | — | — | — | — | 12 |
| Example 47 | — | — | — | — | — | — | — | 14 |
| Example 48 | — | — | — | — | — | — | — | 18 |
| Example 49 | — | — | — | — | — | — | — | 20 |
| Example 50 | — | — | — | — | — | — | — | 10 |
| Example 51 | — | — | — | — | — | — | — | 10 |
| Example 52 | — | — | — | — | — | — | — | 10 |
| Example 53 | — | — | — | — | — | — | — | 10 |
| Example 54 | — | — | — | — | — | — | — | 10 |
| Example 55 | — | — | — | — | — | — | — | 10 |
| Example 56 | — | — | — | — | — | — | — | 10 |
| Example 57 | Jet fountain | Blade | Tungsten | 0.6 | 1400 | 40 | 50 | 12 |
| Example 58 | Jet fountain | Blade | Tungsten | 0.6 | 1400 | 40 | 50 | 14 |
| Example 59 | Jet fountain | Blade | Tungsten | 0.6 | 1400 | 40 | 50 | 15 |
| Example 60 | Jet fountain | Blade | Tungsten | 0.6 | 1400 | 40 | 50 | 20 |
| Example 61 | Jet fountain | Blade | Tungsten | 0.6 | 1400 | 40 | 50 | 25 |
| Example 62 | Jet fountain | Blade | Tungsten | 0.6 | 1400 | 40 | 50 | 30 |
| Example 63 | Jet fountain | Blade | Tungsten | 0.6 | 1400 | 40 | 50 | 12 |
| Example 64 | Jet fountain | Blade | Tungsten | 0.6 | 1400 | 40 | 50 | 12 |
| Example 65 | Jet fountain | Blade | Tungsten | 0.6 | 1400 | 40 | 50 | 12 |
| Example 66 | Jet fountain | Blade | Tungsten | 0.6 | 1400 | 40 | 50 | 12 |
| Example 67 | Jet fountain | Blade | Tungsten | 0.6 | 1400 | 40 | 50 | 12 |
| Example 68 | Jet fountain | Blade | Tungsten | 0.6 | 1400 | 40 | 50 | 12 |
| Example 69 | Jet fountain | Blade | Tungsten | 0.6 | 1400 | 40 | 50 | 12 |

TABLE 29

| | Flattening treatment step | | | | Product | | | | |
|---|---|---|---|---|---|---|---|---|---|
| | | | Surface | Elastic roll | grams per | Raw material | | | |
| | Stage | Temperature | roughness | hardness | square meter | Waste paper | NBKP | LBKP | Contaminant |
| | number | ° C. | μm | Hv | g/m² | % | % | % | amount |
| Example 43 | 9 | 140 | 3 | 98 | 30 | 20 | 60 | 20 | 0.086 |
| Example 44 | 9 | 140 | 3 | 98 | 38 | 20 | 60 | 20 | 0.082 |
| Example 45 | 9 | 140 | 3 | 98 | 40.2 | 20 | 60 | 20 | 0.082 |
| Example 46 | 9 | 140 | 3 | 98 | 42 | 20 | 60 | 20 | 0.089 |
| Example 47 | 9 | 140 | 3 | 98 | 44 | 20 | 60 | 20 | 0.077 |
| Example 48 | 9 | 140 | 3 | 98 | 48 | 20 | 60 | 20 | 0.084 |
| Example 49 | 9 | 140 | 3 | 98 | 54.2 | 20 | 60 | 20 | 0.075 |
| Example 50 | 9 | 140 | 3 | 98 | 54.2 | 20 | 60 | 20 | 0.082 |
| Example 51 | 9 | 140 | 3 | 98 | 54.2 | 20 | 60 | 20 | 0.082 |
| Example 52 | 9 | 140 | 3 | 98 | 35 | 20 | 60 | 20 | 0.076 |
| Example 53 | 9 | 140 | 3 | 98 | 64 | 20 | 60 | 20 | 0.087 |
| Example 54 | 9 | 140 | 3 | 98 | 54.2 | 40 | 40 | 20 | 0.083 |
| Example 55 | 9 | 140 | 3 | 98 | 54.2 | 50 | 30 | 20 | 0.081 |
| Example 56 | 9 | 140 | 3 | 98 | 54.2 | 100 | — | — | 0.074 |
| Example 57 | 9 | 140 | 3 | 98 | 54.2 | 20 | 50 | 30 | 0.071 |
| Example 58 | 9 | 140 | 3 | 98 | 54.2 | 20 | 50 | 30 | 0.081 |
| Example 59 | 9 | 140 | 3 | 98 | 54.2 | 20 | 50 | 30 | 0.072 |
| Example 60 | 9 | 140 | 3 | 98 | 54.2 | 20 | 50 | 30 | 0.086 |
| Example 61 | 9 | 140 | 3 | 98 | 54.2 | 20 | 50 | 30 | 0.070 |
| Example 62 | 9 | 140 | 3 | 98 | 54.2 | 20 | 50 | 30 | 0.088 |
| Example 63 | 9 | 140 | 3 | 98 | 54.2 | 20 | 60 | 20 | 0.082 |
| Example 64 | 9 | 140 | 3 | 98 | 54.2 | 20 | 60 | 20 | 0.082 |
| Example 65 | 9 | 140 | 3 | 98 | 40 | 20 | 60 | 20 | 0.076 |
| Example 66 | 9 | 140 | 3 | 98 | 64 | 20 | 60 | 20 | 0.087 |
| Example 67 | 9 | 140 | 3 | 98 | 54.2 | 40 | 40 | 20 | 0.082 |
| Example 68 | 9 | 140 | 3 | 98 | 54.2 | 50 | 30 | 20 | 0.079 |
| Example 69 | 9 | 140 | 3 | 98 | 54.2 | 100 | — | — | 0.073 |

TABLE 30

| | Quality evaluation | | | | | | | | | | |
|---|---|---|---|---|---|---|---|---|---|---|---|
| | | Paper | | Specific | | Glossiness | Printing | | Yellow | Produc- | Overall |
| | Texture | breakage | Cockle | volume | Glossiness | unevenness | unevenness | Rigidity | change | tivity | evaluation |
| Example 43 | 5.6 | ◯ | ◯ | 1.26 | 57 | 4 | 3 | 66 | 5 | 4 | ◯ |
| Example 44 | 5.6 | ◯ | ◯ | 1.24 | 56 | 4 | 4 | 64 | 4 | 4 | ◯ |
| Example 45 | 5.5 | ◯ | ◯ | 1.23 | 56 | 4 | 4 | 63 | 4 | 4 | ◯ |
| Example 46 | 5.6 | ◯ | ◯ | 1.20 | 56 | 4 | 4 | 65 | 5 | 4 | ◯ |
| Example 47 | 5.5 | ◯ | ◯ | 1.26 | 56 | 4 | 4 | 64 | 5 | 4 | ◯ |
| Example 48 | 5.5 | ◯ | ◯ | .24 | 57 | 3 | 4 | 64 | 5 | 4 | ◯ |
| Example 49 | 5.6 | ◯ | ◯ | 1.23 | 57 | 3 | 3 | 63 | 4 | 4 | ◯ |
| Example 50 | 5.5 | ◯ | ◯ | 1.23 | 56 | 4 | 4 | 63 | 4 | 4 | ◯ |
| Example 51 | 5.5 | ◯ | ◯ | 1.23 | 56 | 4 | 4 | 63 | 4 | 4 | ◯ |
| Example 52 | 5.5 | ◯ | ◯ | 1.23 | 55 | 4 | 4 | 64 | 4 | 4 | ◯ |
| Example 53 | 5.5 | ◯ | ◯ | 1.23 | 56 | 4 | 4 | 63 | 4 | 4 | ◯ |
| Example 54 | 5.6 | ◯ | ◯ | 1.23 | 56 | 4 | 4 | 64 | 4 | 4 | ◯ |
| Example 55 | 5.5 | ◯ | ◯ | 1.20 | 56 | 4 | 4 | 63 | 4 | 4 | ◯ |
| Example 56 | 5.5 | ◯ | ◯ | 1.23 | 56 | 4 | 4 | 63 | 4 | 4 | ◯ |
| Example 57 | 5.6 | ◯ | ◯ | 1.19 | 61 | 4 | 4 | 65 | 5 | 4 | ◯ |
| Example 58 | 5.6 | ◯ | ◯ | 1.24 | 62 | 5 | 5 | 64 | 5 | 4 | ◯ |
| Example 59 | 5.6 | ◯ | ◯ | 1.22 | 62 | 5 | 5 | 64 | 5 | 4 | ◯ |
| Example 60 | 5.6 | ◯ | ◯ | 1.21 | 62 | 5 | 5 | 63 | 5 | 4 | ◯ |
| Example 61 | 5.6 | ◯ | ◯ | 1.18 | 63 | 5 | 5 | 63 | 5 | 4 | ◯ |
| Example 62 | 5.6 | ◯ | ◯ | 1.16 | 63 | 5 | 5 | 62 | 5 | 4 | ◯ |
| Example 63 | 5.5 | ◯ | ◯ | 1.23 | 60 | 4 | 4 | 63 | 4 | 4 | ◯ |
| Example 64 | 5.5 | ◯ | ◯ | 1.23 | 61 | 4 | 4 | 63 | 4 | 4 | ◯ |
| Example 65 | 5.5 | ◯ | ◯ | 1.20 | 62 | 4 | 4 | 63 | 4 | 4 | ◯ |
| Example 66 | 5.5 | ◯ | ◯ | 1.23 | 62 | 4 | 4 | 64 | 4 | 4 | ◯ |
| Example 67 | 5.6 | ◯ | ◯ | 1.23 | 61 | 4 | 4 | 64 | 4 | 4 | ◯ |
| Example 68 | 5.5 | ◯ | ◯ | 1.23 | 62 | 4 | 4 | 63 | 4 | 4 | ◯ |
| Example 69 | 5.5 | ◯ | ◯ | 1.20 | 61 | 4 | 4 | 63 | 4 | 4 | ◯ |

TABLE 31

| | Wet paper forming step | | | Press part (1 P) | | Pre- | | | Pre-calender | Paper |
|---|---|---|---|---|---|---|---|---|---|---|
| | Wire part | Suction mode | | | Felt | dryer | Size press | After dryer | Soft calender | making speed |
| | mode | 1 Stage | 2 Stage | Mode | constitution | Mode | Mode | Mode | Mode | m/min |
| Comparative | Gap | Suction | Suction | Shoe | Double | Single | Gate roll | Single deck | — | 800 |
| Example 8 | former | roll | blade | press | felt | deck | | | | |
| Comparative | Gap | Suction | Suction | Shoe | Double | Single | Gate roll | Single deck | — | 1200 |
| Example 9 | former | roll | blade | press | felt | deck | | | | |
| Comparative | Gap | Suction | Suction | Shoe | Double | Single | — | Single deck | 1 Nip 1 stack | 1600 |
| Example 10 | former | roll | blade | press | felt | deck | | | | |
| Comparative | Gap | Suction | Suction | Shoe | Double | Single | — | Single deck | 1 Nip 1 stack | 1800 |
| Example 11 | former | roll | blade | press | felt | deck | | | | |
| Comparative | Gap | Suction | Suction | Shoe | Double | Single | — | Single deck | 1 Nip 1 stack | 1600 |
| Example 12 | former | roll | blade | press | felt | deck | | | | |
| Comparative | Gap | Suction | Suction | Shoe | Double | Single | — | Single deck | 1 Nip 1 stack | 1600 |
| Example 13 | former | roll | blade | press | felt | deck | | | | |
| Comparative | Gap | Suction | Suction | Shoe | Double | Single | Gate roll | Single deck | — | 800 |
| Example 15 | former | roll | blade | press | felt | deck | | | | |
| Comparative | Gap | Suction | Suction | Shoe | Double | Single | Gate roll | Single deck | — | 1200 |
| Example 16 | former | roll | blade | press | felt | deck | | | | |
| Comparative | Gap | Suction | Suction | Shoe | Double | Single | — | Single deck | 1 Nip 1 stack | 1600 |
| Example 17 | former | roll | blade | press | felt | deck | | | | |
| Comparative | Gap | Suction | Suction | Shoe | Double | Single | — | Single deck | 1 Nip 1 stack | 1800 |
| Example 18 | former | roll | blade | press | felt | deck | | | | |
| Comparative | Gap | Suction | Suction | Shoe | Double | Single | — | Single deck | 1 Nip 1 stack | 1600 |
| Example 19 | former | roll | blade | press | felt | deck | | | | |
| Comparative | Gap | Suction | Suction | Shoe | Double | Single | — | Single deck | 1 Nip 1 stack | 1600 |
| Example 20 | former | roll | blade | press | felt | deck | | | | |
| Comparative | Gap | Suction | Suction | Shoe | Double | Single | — | Single deck | — | 1600 |
| Example 22 | former | roll | blade | press | felt | deck | | | | |
| Comparative | Gap | Suction | Suction | Shoe | Double | Single | — | Single deck | — | 1600 |
| Example 23 | former | roll | blade | press | felt | deck | | | | |
| Comparative | Gap | Suction | Suction | Shoe | Double | Single | — | Single deck | — | 1600 |
| Example 24 | former | roll | blade | press | felt | deck | | | | |
| Comparative | Gap | Suction | Suction | Shoe | Double | Single | — | Single deck | — | 1600 |
| Example 25 | former | roll | blade | press | felt | deck | | | | |
| Comparative | Gap | Suction | Suction | Shoe | Double | Single | — | Single deck | — | 1600 |
| Example 26 | former | roll | blade | press | felt | deck | | | | |

TABLE 32

| | First coating apparatus | | | | |
|---|---|---|---|---|---|
| | | | Roll surface | | Coating amount |
| | | Hardness | roughness | | Both faces |
| | Coater mode | Hv | μm | Material | g/m² |
| Comparative | — | — | — | — | — |
| Example 8 | | | | | |
| Comparative | — | — | — | — | — |
| Example 9 | | | | | |
| Comparative | — | — | — | — | — |
| Example 10 | | | | | |
| Comparative | — | — | — | — | — |
| Example 11 | — | — | — | — | — |
| Comparative | — | — | — | — | — |
| Example 12 | | | | | |
| Comparative | — | — | — | — | — |
| Example 13 | | | | | |
| Comparative | Roll | 80 | 5 | Polyethylene blended urethane roll | 10 |
| Example 15 | | | | | |
| Comparative | Roll | 80 | 5 | Polyethylene blended urethane roll | 10 |
| Example 16 | | | | | |
| Comparative | Roll | 80 | 5 | Polyethylene blended urethane roll | 10 |
| Example 17 | | | | | |
| Comparative | Roll | 80 | 5 | Polyethylene blended urethane roll | 10 |
| Example 18 | | | | | |
| Comparative | Roll | 80 | 5 | Polyethylene blended urethane roll | 22 |
| Example 19 | | | | | |
| Comparative | Roll | 80 | 5 | Polyethylene blended urethane roll | 24 |
| Example 20 | | | | | |
| Comparative | Roll | 80 | 5 | Polyethylene blended urethane roll | 10 |
| Example 22 | | | | | |
| Comparative | Roll | 80 | 5 | Polyethylene blended urethane roll | 10 |
| Example 23 | | | | | |
| Comparative | Roll | 80 | 5 | Polyethylene blended urethane roll | 10 |
| Example 24 | | | | | |
| Comparative | Roll | 80 | 5 | Polyethylene blended urethane roll | 10 |
| Example 25 | | | | | |
| Comparative | Roll | 80 | 5 | Polyethylene blended urethane roll | 10 |
| Example 26 | | | | | |

TABLE 33

| | Second coating apparatus | | | | | | |
|---|---|---|---|---|---|---|---|
| | | | | Thickness | Hardness | | Fountain angle |
| | Coating mode | Mode | Material | mm | Hv | Bevel angle | Degree |
| Comparative | Jet fountain | Blade | Tungsten | 0.6 | 1400 | 40 | 50 |
| Example 8 | | | | | | | |
| Comparative | Jet fountain | Blade | Tungsten | 0.6 | 1400 | 40 | 50 |
| Example 9 | | | | | | | |
| Comparative | Jet fountain | Blade | Tungsten | 0.6 | 1400 | 40 | 50 |
| Example 10 | | | | | | | |
| Comparative | Jet fountain | Blade | Tungsten | 0.6 | 1400 | 40 | 50 |
| Example 11 | | | | | | | |
| Comparative | Jet fountain | Blade | Tungsten | 0.6 | 1400 | 40 | 50 |
| Example 12 | | | | | | | |
| Comparative | Jet fountain | Blade | Tungsten | 0.6 | 1400 | 40 | 50 |
| Example 13 | | | | | | | |
| Comparative | — | — | — | — | — | — | — |
| Example 15 | | | | | | | |
| Comparative | — | — | — | — | — | — | — |
| Example 16 | | | | | | | |
| Comparative | — | — | — | — | — | — | — |
| Example 17 | | | | | | | |
| Comparative | — | — | — | — | — | — | — |
| Example 18 | | | | | | | |
| Comparative | — | — | — | — | — | — | — |
| Example 19 | | | | | | | |
| Comparative | — | — | — | — | — | — | — |
| Example 20 | | | | | | | |
| Comparative | Jet fountain | Blade | Tungsten | 0.6 | 1400 | 40 | 50 |
| Example 22 | | | | | | | |
| Comparative | Jet fountain | Blade | Tungsten | 0.6 | 1400 | 40 | 50 |
| Example 23 | | | | | | | |
| Comparative | Jet fountain | Blade | Tungsten | 0.6 | 1400 | 40 | 50 |
| Example 24 | | | | | | | |
| Comparative | Jet fountain | Blade | Tungsten | 0.6 | 1400 | 40 | 50 |
| Example 25 | | | | | | | |
| Comparative | Jet fountain | Blade | Tungsten | 0.6 | 1400 | 40 | 50 |
| Example 26 | | | | | | | |

TABLE 34

| | | | | | | | | Coating |
|---|---|---|---|---|---|---|---|---|
| | | | | | | | | amount |
| | Second coating apparatus (Back) | | | | | | | Product |
| | | | | | | | Fountain | coating |
| | | | | Thickness | Hardness | | angle | amount |
| | Coating mode | Mode | Material | mm | Hv | Bevel angle | Degree | g/m² |
| Comparative | Jet fountain | Blade | Tungsten | 0.6 | 1400 | 40 | 50 | 12 |
| Example 8 | | | | | | | | |
| Comparative | Jet fountain | Blade | Tungsten | 0.6 | 1400 | 40 | 50 | 12 |
| Example 9 | | | | | | | | |
| Comparative | Jet fountain | Blade | Tungsten | 0.6 | 1400 | 40 | 50 | 12 |
| Example 10 | | | | | | | | |
| Comparative | Jet fountain | Blade | Tungsten | 0.6 | 1400 | 40 | 50 | 12 |
| Example 11 | | | | | | | | |
| Comparative | Jet fountain | Blade | Tungsten | 0.6 | 1400 | 40 | 50 | 22 |
| Example 12 | | | | | | | | |
| Comparative | Jet fountain | Blade | Tungsten | 0.6 | 1400 | 40 | 50 | 24 |
| Example 13 | | | | | | | | |
| Comparative | — | — | — | — | — | — | — | 10 |
| Example 15 | | | | | | | | |
| Comparative | — | — | — | — | — | — | — | 10 |
| Example 16 | | | | | | | | |
| Comparative | — | — | — | — | — | — | — | 10 |
| Example 17 | | | | | | | | |
| Comparative | — | — | — | — | — | — | — | 10 |
| Example 18 | | | | | | | | |
| Comparative | — | — | — | — | — | — | — | 22 |
| Example 19 | | | | | | | | |
| Comparative | — | — | — | — | — | — | — | 24 |
| Example 20 | | | | | | | | |
| Comparative | Jet fountain | Blade | Tungsten | 0.6 | 1400 | 40 | 50 | 24 |
| Example 22 | | | | | | | | |
| Comparative | Jet fountain | Blade | Tungsten | 0.6 | 1400 | 40 | 50 | 24 |
| Example 23 | | | | | | | | |
| Comparative | Jet fountain | Blade | Tungsten | 0.6 | 1400 | 40 | 50 | 24 |
| Example 24 | | | | | | | | |
| Comparative | Jet fountain | Blade | Tungsten | 0.6 | 1400 | 40 | 50 | 24 |
| Example 25 | | | | | | | | |
| Comparative | Jet fountain | Blade | Tungsten | 0.6 | 1400 | 40 | 50 | 24 |
| Example 26 | | | | | | | | |

TABLE 35

| | Flattening treatment step | | | | Product grams | Raw material | | | |
|---|---|---|---|---|---|---|---|---|---|
| | | | Surface | Elastic roll | per square | Waste | | | |
| | Stage | Temperature | roughness | hardness | meter | paper | NBKP | LBKP | Contaminant |
| | number | ° C. | μm | Hv | g/m² | % | % | % | amount |
| Comparative | 9 | 140 | 3 | 98 | 54.2 | 20 | 60 | 20 | 0.084 |
| Example 8 | | | | | | | | | |
| Comparative | 9 | 140 | 3 | 98 | 54.2 | 20 | 60 | 20 | 0.089 |
| Example 9 | | | | | | | | | |
| Comparative | 9 | 140 | 3 | 98 | 54.2 | 20 | 60 | 20 | 0.087 |
| Example 10 | | | | | | | | | |
| Comparative | 9 | 140 | 3 | 98 | 54.2 | 20 | 60 | 20 | 0.092 |
| Example 11 | | | | | | | | | |
| Comparative | 9 | 140 | 3 | 98 | 54.2 | 20 | 60 | 20 | 0.095 |
| Example 12 | | | | | | | | | |
| Comparative | 9 | 140 | 3 | 98 | 54.2 | 20 | 60 | 20 | 0.086 |
| Example 13 | | | | | | | | | |
| Comparative | 9 | 140 | 3 | 98 | 54.2 | 20 | 60 | 20 | 0.089 |
| Example 15 | | | | | | | | | |
| Comparative | 9 | 140 | 3 | 98 | 54.2 | 20 | 60 | 20 | 0.086 |
| Example 16 | | | | | | | | | |
| Comparative | 9 | 140 | 3 | 98 | 54.2 | 20 | 60 | 20 | 0.089 |
| Example 17 | | | | | | | | | |
| Comparative | 9 | 140 | 3 | 98 | 54.2 | 20 | 60 | 20 | 0.090 |
| Example 18 | | | | | | | | | |
| Comparative | 9 | 140 | 3 | 98 | 54.2 | 20 | 60 | 20 | 0.088 |
| Example 19 | | | | | | | | | |
| Comparative | 9 | 140 | 3 | 98 | 54.2 | 20 | 60 | 20 | 0.092 |
| Example 20 | | | | | | | | | |
| Comparative | 9 | 140 | 3 | 98 | 54.2 | 10 | 70 | 20 | 0.088 |
| Example 22 | | | | | | | | | |
| Comparative | 9 | 140 | 3 | 98 | 54.2 | 20 | 60 | 20 | 0.095 |
| Example 23 | | | | | | | | | |
| Comparative | 9 | 140 | 3 | 98 | 54.2 | 30 | 60 | 10 | 0.086 |
| Example 24 | | | | | | | | | |
| Comparative | 9 | 140 | 3 | 98 | 54.2 | 50 | 30 | 20 | 0.089 |
| Example 25 | | | | | | | | | |
| Comparative | 9 | 140 | 3 | 98 | 54.2 | 100 | — | — | 0.091 |
| Example 26 | | | | | | | | | |

TABLE 36

| | Quality evaluation | | | | | | | | | | |
|---|---|---|---|---|---|---|---|---|---|---|---|
| | | Paper | | Specific | | Glossiness | Printing | | Yellow | Produc- | Overall |
| | Texture | breakage | Cockle | volume | Glossiness | unevenness | unevenness | Rigidity | change | tivity | evaluation |
| Comparative | 5.6 | X | Δ | 1.18 | 62 | 3 | 3 | 56 | 4 | 2 | X |
| Example 8 | | | | | | | | | | | |
| Comparative | 5.6 | X | X | 1.17 | 61 | 3 | 3 | 54 | 4 | 1 | X |
| Example 9 | | | | | | | | | | | |
| Comparative | 5.6 | X | X | 1.18 | 53 | 2 | 2 | 45 | 3 | 1 | X |
| Example 10 | | | | | | | | | | | |
| Comparative | 5.6 | X | X | 1.17 | 52 | 1 | 2 | 43 | 5 | 1 | X |
| Example 11 | | | | | | | | | | | |
| Comparative | 5.6 | X | X | 1.15 | 56 | 2 | 2 | 42 | 5 | 1 | X |
| Example 12 | | | | | | | | | | | |
| Comparative | 5.6 | X | X | 1.14 | 57 | 2 | 3 | 41 | 5 | 1 | X |
| Example 13 | | | | | | | | | | | |
| Comparative | 5.6 | ◯ | Δ | 1.19 | 56 | 2 | 2 | 55 | 5 | 2 | X |
| Example 15 | | | | | | | | | | | |
| Comparative | 5.6 | ◯ | Δ | 1.18 | 54 | 2 | 2 | 54 | 5 | 2 | X |
| Example 16 | | | | | | | | | | | |
| Comparative | 5.6 | ◯ | Δ | 1.17 | 57 | 3 | 3 | 43 | 5 | 2 | X |
| Example 17 | | | | | | | | | | | |
| Comparative | 5.6 | ◯ | Δ | 1.18 | 55 | 2 | 2 | 44 | 5 | 1 | X |
| Example 18 | | | | | | | | | | | |
| Comparative | 5.6 | ◯ | Δ | 1.19 | 58 | 2 | 3 | 54 | 5 | 2 | X |
| Example 19 | | | | | | | | | | | |
| Comparative | 5.6 | ◯ | Δ | 1.17 | 59 | 2 | 3 | 53 | 5 | 2 | X |
| Example 20 | | | | | | | | | | | |
| Comparative | 5.6 | X | Δ | 1.17 | 62 | 5 | 4 | 54 | 5 | 4 | X |
| Example 22 | | | | | | | | | | | |
| Comparative | 5.6 | X | Δ | 1.14 | 62 | 5 | 4 | 74 | 5 | 4 | X |
| Example 23 | | | | | | | | | | | |
| Comparative | 5.6 | X | Δ | 1.01 | 62 | 5 | 4 | 58 | 5 | 4 | X |
| Example 24 | | | | | | | | | | | |
| Comparative | 5.6 | X | Δ | 0.94 | 61 | 4 | 4 | 57 | 5 | 4 | X |
| Example 25 | | | | | | | | | | | |
| Comparative | 5.6 | X | Δ | 0.93 | 60 | 4 | 4 | 57 | 4 | 4 | X |
| Example 26 | | | | | | | | | | | |

“Discussions”

Examples according to the present invention shows that high quality paper can be obtained albeit in high speed paper making, as compared with the cases in Comparative Examples.

### BRIEF DESCRIPTION OF THE DRAWINGS

FIG. 1 is a schematic explanatory diagram showing a first zone of an apparatus constitution example of a paper making machine.

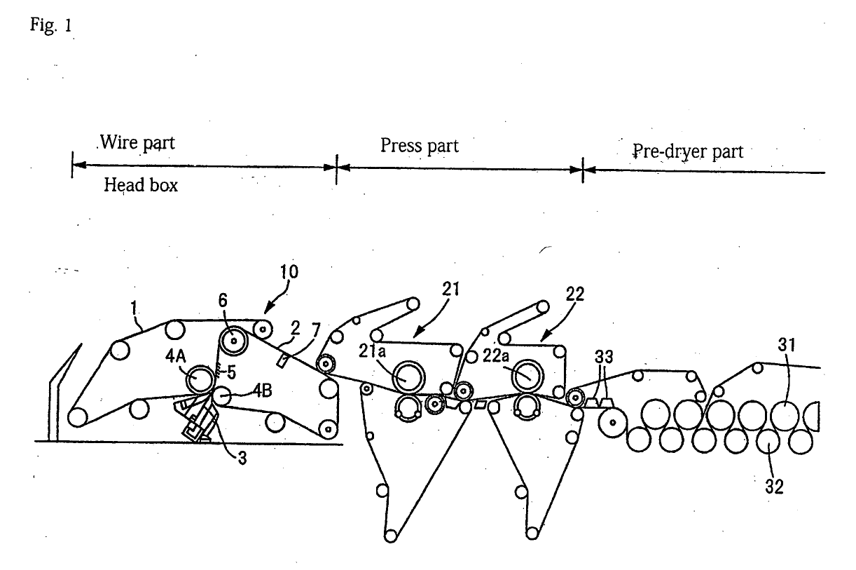

FIG. 2 is a schematic explanatory diagram showing a second zone of an apparatus constitution example of a paper making machine.

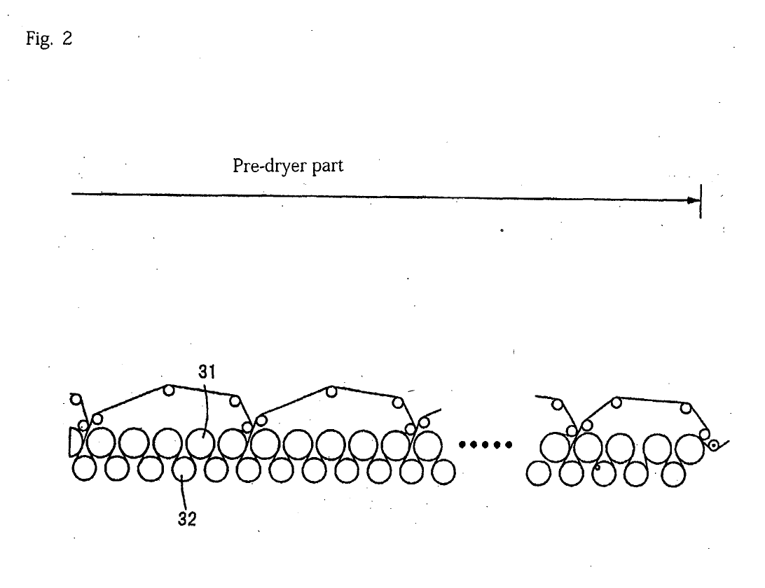

FIG. 3 is a schematic explanatory diagram showing a third zone of an apparatus constitution example of a paper making machine.

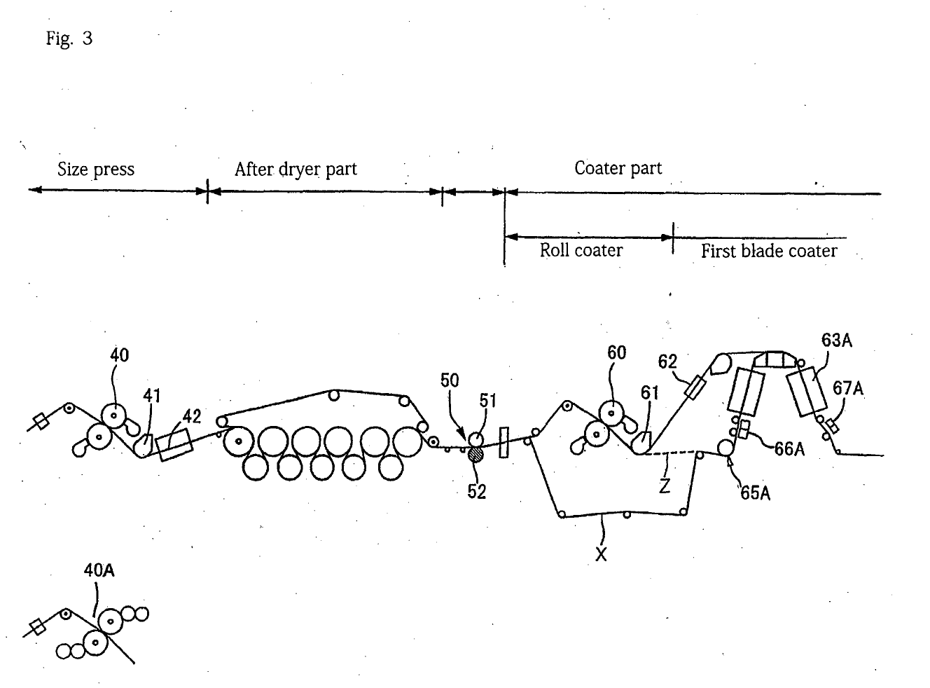

FIG. 4 is a schematic explanatory diagram showing a forth zone of an apparatus constitution example of a paper making machine.

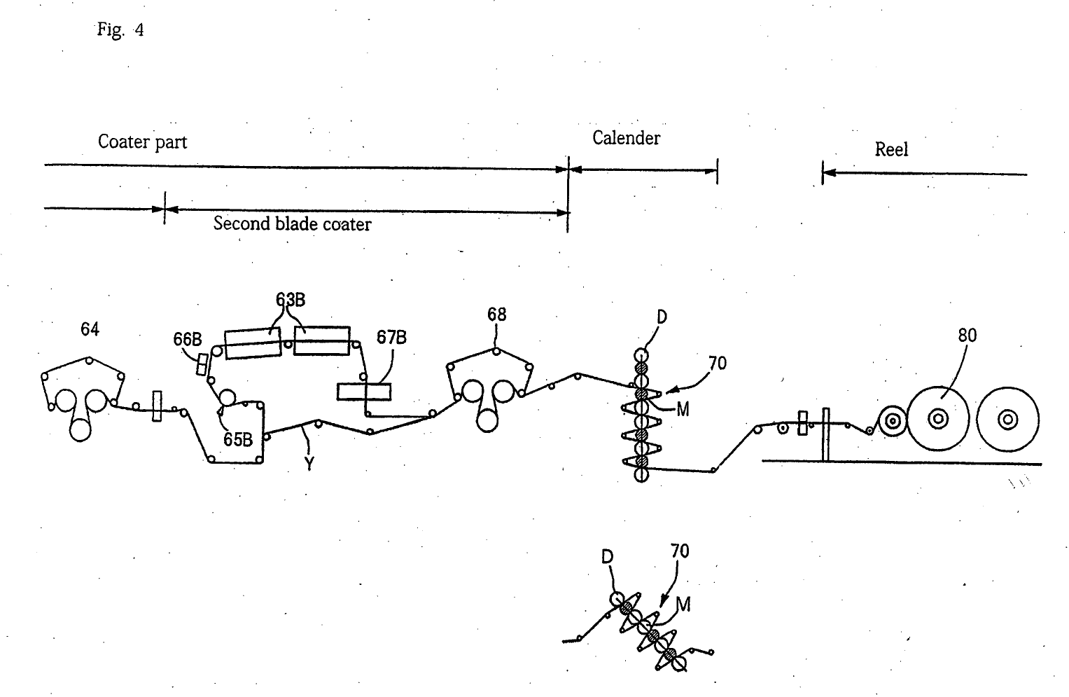

FIG. 5 is a schematic explanatory diagram showing a modified example of the calender part in the forth zone of an apparatus constitution example of a paper making machine.

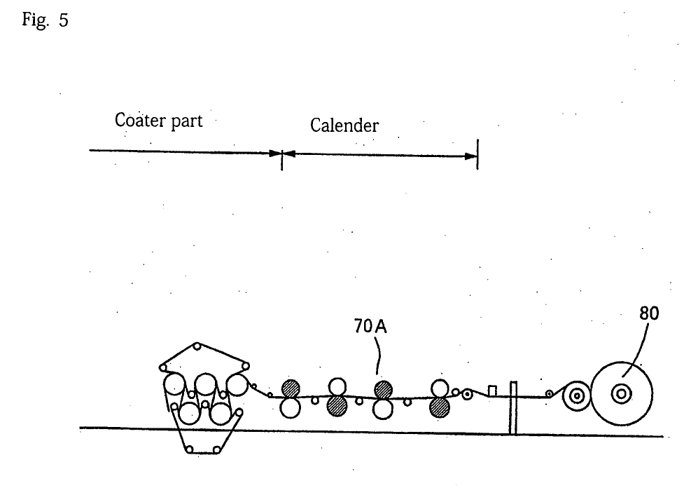

FIG. 6 is a schematic explanatory diagram showing the ejection of paper stock of a head box.

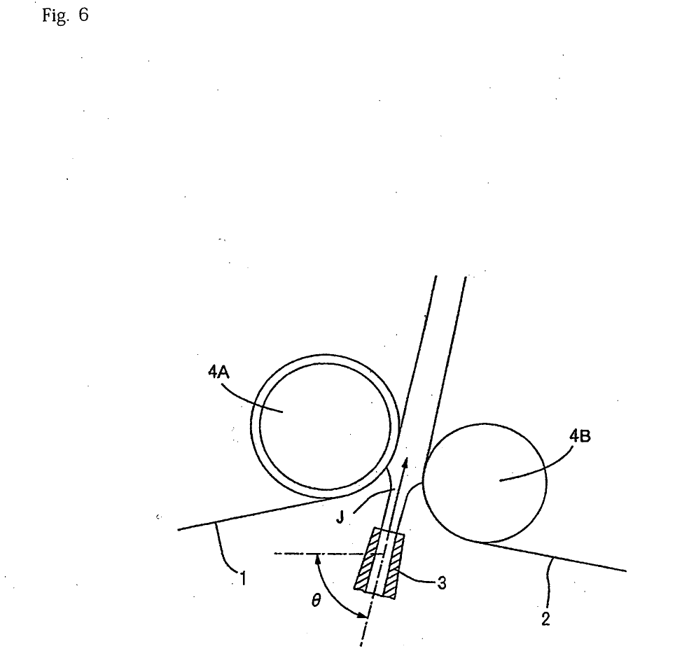

FIG. 7 is a schematic explanatory diagram showing a heating metal roll.

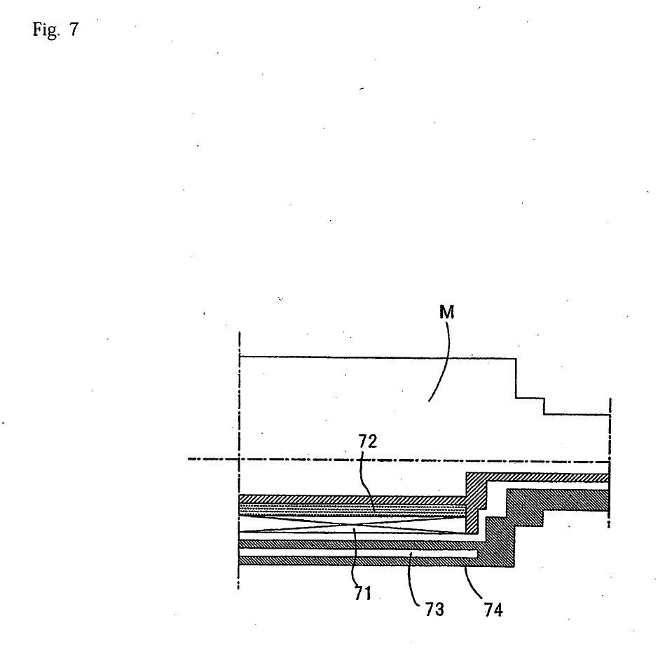

FIG. 8 is a schematic explanatory diagram showing an example of an internal heating device by electromagnetic induction action.

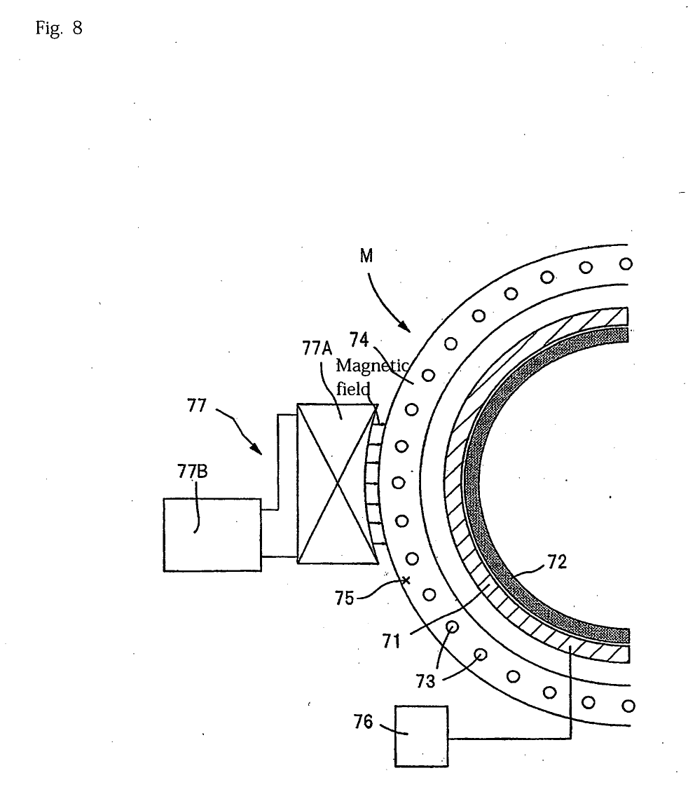

FIG. 9 is a schematic explanatory diagram showing an example of a cleaning apparatus.

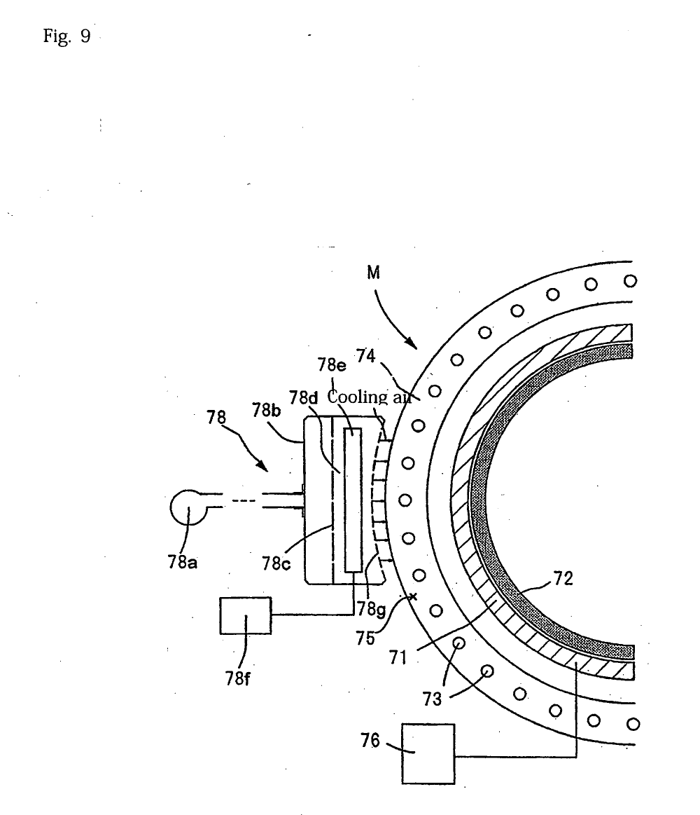

FIG. 10 is a schematic explanatory diagram showing an example of a blade coating machine.

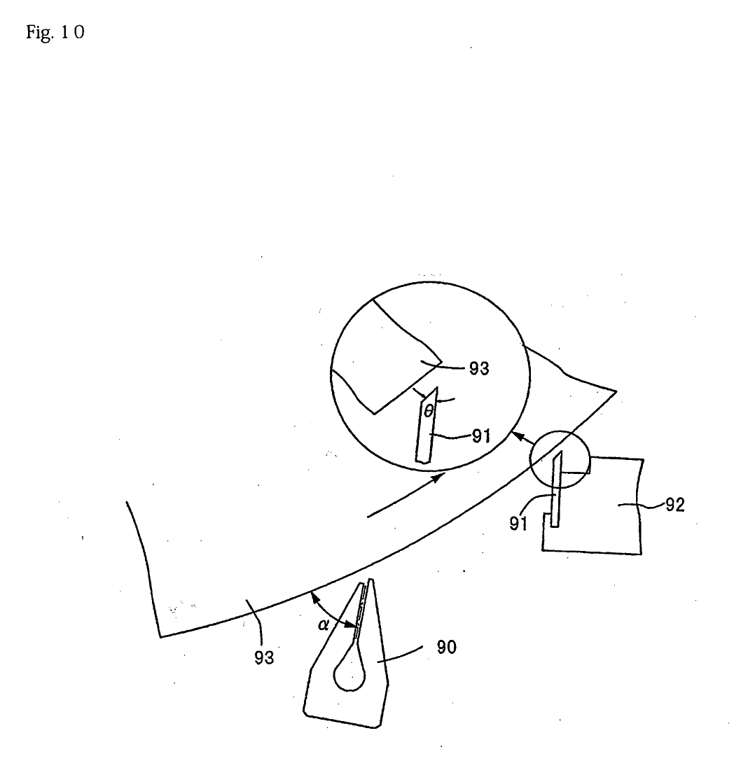

1. A process for producing a coated paper in which continuous steps are incorporated successively within on-machine, the process comprising:
a step of making a paper with a twin wire former in which a paper material is injected from a head box between two wires each of which loops to form a paper layer;
an undercoating step of applying an undercoating liquid to a dry web by a size press;
a step of drying the undercoating liquid
a first flattening treatment step of performing a flattening treatment by a pre-calender;
a face coating step of applying a face coating liquid by selecting a single coating step of (1) or (2) as follows, or a coating step of performing the step (2) after performing the step (1),
(1) a roll coater coating step of roll-coating one side and the other side of a paper to be coated with an aqueous coating liquid consisting mainly of an adhesive and a pigment, and then drying the coated paper,
(2) a blade coater coating step of blade-coating one side and the other side of a paper to be coated with an aqueous coating liquid consisting mainly of an adhesive and a pigment, and then drying the coated paper; and
a step of subjecting the coated paper to a flattening treatment using a heat soft calender comprising a combination of a metal roll and an elastic roll formed in a multi-stage having at least two nips.

2. The process for producing a coated paper according to claim 1, wherein the pre-calender comprises a heated metal roll as at least one roll of a pair of rolls.

3. The process for producing a coated paper according to claim 1 or 2, wherein the pre-calender comprises a pair of a metal roll and an elastic roll and the metal roll is heated to a temperature of 100 to 300° C.

4. The process for producing a coated paper according to claim 1 or 2, wherein the flattening treatment is performed by the pre-calender comprising the metal roll heated to a temperature of 230° C. or more.

5. The process for producing a coated paper according to claim 3, wherein the flattening treatment is performed by the pre-calender comprising the metal roll heated to a temperature of 230° C. or more.

6. A coated paper produced by the process for producing according to claim 1 or 2.
